(19) United States
(12) Patent Application Publication
(10) Pub. No.: US 2011/0157312 A1
(43) Pub. Date: Jun. 30, 2011

(54) IMAGE PROCESSING APPARATUS AND METHOD

(75) Inventor: Itaru Kawakami, Kanagawa (JP)

(73) Assignee: Sony Corporation, Tokyo (JP)

(21) Appl. No.: 12/972,796

(22) Filed: Dec. 20, 2010

(30) Foreign Application Priority Data
Dec. 28, 2009 (JP) 2009-296950

(51) Int. Cl. H04N 13/02

(52) U.S. Cl. 348/46; 348/E13.074

(57) ABSTRACT

An image processing apparatus includes: a creating means that creates identification information identifying a type of an image of image data among a 2D image for planar viewing, a 3D image for stereoscopic viewing including left and right images, and a duplex image which is capable of both stereoscopic viewing including the left and right images and planar viewing with disparity lower than that of the 3D image; and a transmitting means that transmits the identification information created by the creating means and the image data.

### BACKGROUND OF THE INVENTION

1. Field of the Invention

The present invention relates to an image processing apparatus and method, and more particularly, to an image processing apparatus and method capable of executing a process more suitable to the characteristics of the image.

2. Description of the Related Art

In the related art, there is a 3D image capable of stereoscopic viewing by preparing two images for the left and right eyes of each frame image and alternately outputting such images.

It has been proposed that a flag for distinguishing a 2D image in which a frame image is displayed as a single image from a 3D image is added to the image data (code stream), and the flag is used in the image reproducing (e.g., refer to Japanese Unexamined Patent Application Publication No. 2004-357156)

In addition, it was also proposed that disparity information representing disparity between left and right images is added to the image data (code stream) (e.g., refer to Japanese Unexamined Patent Application Publication No. 63-198498).

Furthermore, it was also proposed that various other kinds of control are performed by adding more information regarding disparity to the image data (e.g., refer to Japanese Unexamined Patent Application Publication No. 2008-109267).

On the other hand, there is also, in 3D images, a duplex image that has no problems to be seen as a 2D image in practice by reducing disparity. In the case of a 3D image capable of stereoscopic viewing by wearing dedicated 3D spectacles, the left and right images are displayed to be overlapped. Therefore, in the case of a typical 3D image having high disparity, it is difficult to see the 3D image with the naked eye (since the displaced left and right images are seen to be overlapped, image quality sufficient to allow a user to see fails to be provided).

However, since the duplex image with little disparity has a positional displacement between the left and right images low enough to not burden the human eye with an uncomfortable feeling at all, a user can watch the duplex image as a 3D image by wearing 3D spectacles or watch the duplex image as a 2D image without wearing the 3D spectacles.

### SUMMARY OF THE INVENTION

However, in the related art, it is difficult to distinguish such a duplex image from the typical 3D image. Therefore, it may fail to control the image reproduction processing or the like such that characteristics of the image can be sufficiently utilized.

The present invention has been proposed to address the aforementioned problems, and it is desirable to provide a method of performing a process more suitable to the characteristics of the image.

According to an embodiment of the invention, there is provided an image processing apparatus including: a creating means that creates identification information identifying a type of an image of image data among a 2D image for planar viewing, a 3D image for stereoscopic viewing including left and right images, and a duplex image which is capable of both stereoscopic viewing including the left and right images and planar viewing with disparity lower than that of the 3D image; and a transmitting means that transmits the identification information created by the creating means and the image data.

The image processing apparatus may further include an encoding means that encodes the image data to create encoded data, wherein the transmitting means transmits the identification information created by the creating means and the encoded data created by the encoding means.

The creating means may create, as identification information, a flag having a value of “00” when the image of the image data corresponds to the 2D image, creates a flag having a value of “10” when the image of the image data corresponds to the 3D image, and creates a flag having a value of “01” or “11” when the image of the image data corresponds to the duplex image.

The creating means may create, as identification information, a flag having a value of “10” when the image of the image data corresponds to the 2D image, creates a flag having a value of “01” when the image of the image data corresponds to the 3D image, and creates a flag having a value of “11” when the image of the image data corresponds to the duplex image.

According to another embodiment of the invention, there is provided an image processing method of an image processing apparatus, the method including: creating, as identification information, a flag for identifying an image of image data corresponds to which one of a 2D image for planar viewing, a 3D image for stereoscopic viewing including left and right images, and a duplex image which is capable of both stereoscopic viewing including the left and right images and planar viewing with disparity lower than that of the 3D image; and transmitting the created flag and the image data.

According to still another embodiment of the invention, there is provided an image processing apparatus including: a receiving means that receives image data and identification information identifying a type of an image of image data among a 2D image for planar viewing, a 3D image for stereoscopic viewing including left and right images, and a duplex image which is capable of both stereoscopic viewing including the left and right images and planar viewing with disparity lower than that of the 3D image; a determination means that determines a value of the identification information received by the receiving means; and a processing means that performs a process corresponding to the value determined by the determination means.

The processing means may display an icon corresponding to the type of the image of the image data indicated by the value determined by the determination means.

The processing means may turn a light emitting diode (LED) on or off depending on the type of the image of the image data indicated by the value determined by the determination means.

The processing means may set and display a display size of the image of the image data based on the type of the image of the image data indicated by the value determined by the determination means.

The processing means may set and display an aspect ratio of the image of the image data based on the type of the image of the image data indicated by the value determined by the determination means.

The processing means may set and display a thickness of an image frame of the image of the image data based on the type of the image of the image data indicated by the value determined by the determination means.

The processing means may output a voice as notification of the type of the image of the image data indicated by the value determined by the determination means.

The processing means may control 3D spectacles used by a user when the image of the image data is seen stereoscopically to notify a user of the type of the image of the image data indicated by the value determined by the determination means.

The processing means may display a notification image as notification of the type of the image of the image data indicated by the value determined by the determination means before displaying the image of image data.

According to further another embodiment of the invention, there is provided An image processing method of an image processing apparatus, the method including: receiving image data and identification information identifying a type of an image of image data among a 2D image for planar viewing, a 3D image for stereoscopic viewing including left and right images, and a duplex image which is capable of both stereoscopic viewing including the left and right images and planar viewing with disparity lower than that of the 3D image; determining a value of the received identification information; and performing a process corresponding to the determined value.

According to an embodiment of the invention, a flag identifying a type of an image of image data among a 2D image for planar viewing, a 3D image for stereoscopic viewing including left and right images, and a duplex image which is capable of both stereoscopic viewing including the left and right images and planar viewing with disparity lower than that of the 3D image is created and added to the image data.

According to another embodiment of the invention, image data and identification information identifying a type of an image of image data among a 2D image for planar viewing, a 3D image for stereoscopic viewing including left and right images, and a duplex image which is capable of both stereoscopic viewing including the left and right images and planar viewing with disparity lower than that of the 3D image are received, a value of the identification information is determined; and a process corresponding to the determined value is performed.

According to the present invention, it is possible to process an image. Particularly, it is possible to perform a process suitable to the characteristics of the image.

### BRIEF DESCRIPTION OF THE DRAWINGS

FIG. 1 is a block diagram illustrating a main configuration example of an image processing apparatus according to an embodiment of the invention.

FIG. 2 is a diagram illustrating a configuration example of a duplex imaging apparatus.

FIG. 3 is a diagram illustrating details of a configuration of a duplex imaging apparatus.

FIG. 4 is a diagram illustrating a configuration example of a polarization filter.

FIG. 5 is a diagram illustrating exemplary appearance of creating left and right images.

FIG. 6 is a diagram illustrating a configuration example of a polarization plate.

FIG. 7 is a diagram illustrating another configuration example of a duplex imaging apparatus.

FIG. 8 is a diagram illustrating a light propagating direction.

FIG. 9 is a flowchart illustrating an exemplary flow of a flag addition process.

FIGS. 10A to 10C are diagrams illustrating exemplary flags.

FIG. 11 is a block diagram illustrating a main configuration example of an image processing apparatus according to an embodiment of the invention.

FIG. 12 is a flowchart illustrating an exemplary flow of a flag use process.

FIGS. 13A to 13C are diagrams illustrating exemplary notification display.

FIGS. 14A and 14B are diagrams illustrating a configuration example of an image type notification LED.

FIG. 15 is a flowchart illustrating another exemplary flow of the flag use process.

FIGS. 16A and 16B are diagrams illustrating exemplary appearance of modifying an image display size.

FIGS. 17A to 17C are diagrams illustrating exemplary appearance of modifying an image frame thickness.

FIG. 18 is a flowchart illustrating yet another exemplary flow of the flag use process.

FIGS. 19A to 19D are diagrams illustrating an exemplary notification method in 3D spectacles.

FIG. 20 is a diagram illustrating still yet another exemplary flow of the flag use process.

FIGS. 21A to 21C are diagrams illustrating an exemplary previous notification display image.

FIG. 22 is a flowchart illustrating further another exemplary flow of the flag use process.

FIG. 23 is a block diagram illustrating a configuration example of a network system according to an embodiment of the invention.

FIG. 24 is a diagram illustrating a display example of introduction information.

FIG. 25 is a flowchart illustrating still further another exemplary flow of the flag use process.

FIG. 26 is a block diagram illustrating another configuration example of the image processing apparatus according to an embodiment of the invention.

FIG. 27 is a diagram illustrating examples of the flag and the disparity information.

FIG. 28 is a flowchart illustrating an exemplary flow of a flag/disparity information adding process.

FIG. 29 is a diagram illustrating another configuration example of the image processing apparatus according to an embodiment of the invention.

FIG. 30 is a graph illustrating an example of a disparity amount.

FIG. 31 is a flowchart illustrating an exemplary flow of the flag/disparity information use process.

FIG. 32 is a block diagram illustrating a main configuration example of a personal computer according to an embodiment of the invention.

### DESCRIPTION OF THE PREFERRED EMBODIMENTS

Hereinafter, configurations for embodying the invention (hereinafter, referred to as embodiments of the invention) will be described. The descriptions will be made in the following sequence.

1. First Embodiment (Image Processing Apparatus)

2. Second Embodiment (Image Processing Apparatus)

3. Third Embodiment (Network System)

4. Fourth Embodiment (Image Processing Apparatus)

5. Fifth Embodiment (Image Processing Apparatus)

6. Sixth Embodiment (Personal Computer)

### 1. First Embodiment

Configuration of Image Processing Apparatus

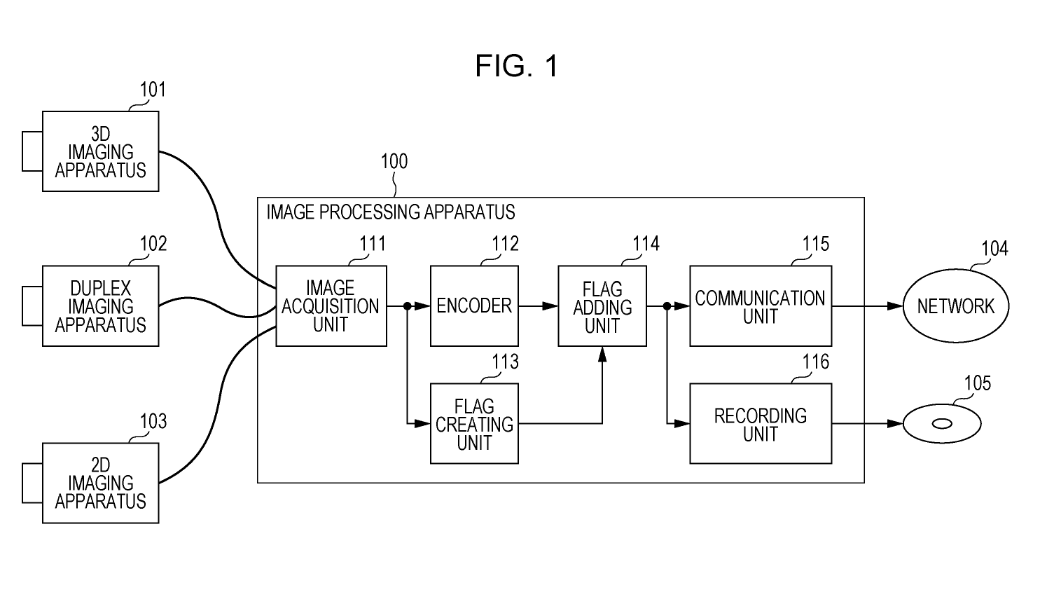

FIG. 1 is a block diagram illustrating a main configuration example of the image processing apparatus according to an embodiment of the invention.

The image processing apparatus 100 shown in FIG. 1 encodes an image, creates a flag corresponding to characteristics of the image, and adds the flag to a code stream.

The image processing apparatus 100 includes an image acquisition unit 111, an encoder 112, a flag creating unit 113, a flag adding unit 114, a communication unit 115, and a recording unit 116.

The image acquisition unit 111 acquires image data captured and obtained from a 3D imaging apparatus 101, a duplex imaging apparatus 102, or a 2D imaging apparatus 103.

The 3D imaging apparatus 101 captures an image of the subject to create a 3-dimensional (3D) image for stereoscopic viewing. The duplex imaging apparatus 102 captures an image of the subject to create a duplex image for both stereoscopic and planar views. The 2D imaging apparatus 103 captures an image of the subject to create a 2-dimensional (2D) image for planar viewing.

Here, the 3D image includes two kinds of images for human left and right eyes and is capable of providing stereoscopic viewing using dedicated 3D spectacles. The two kinds of images for left and right eyes of the 3D image are alternately displayed. The 3D spectacles display the right-eye image on a monitor in a user's right-eye side and display the left-eye image on a monitor in a user's left-eye side by opening and closing a polarization plate (not shown) in synchronization with a synchronization signal for the image display thereof. That is, a user can see the left-eye image through the left eye and see the right-eye image through the right eye by viewing the 3D image using the 3D spectacles. Since the left-eye and right-eye images of the 3D image have disparity, a user can see the 3D image stereoscopically.

In addition, display switching between the left and right images in the 3D image is performed at a rate equal to or higher than a normal frame rate. Therefore, the left and right images are seen to overlap with each other through the human eye (when seen with the naked eye without using 3D spectacles). Since disparity exists between the left and right images, and positions are displaced as much as the disparity, display quality seen by the human eye is degraded as little as being not recognized in a normal image. Here, “the naked eye” mean a state of not wearing 3D spectacles and does not include contact lenses or spectacles other than the 3D spectacles (regardless of whether or not spectacles or contact lenses are worn, if a user is not wearing 3D spectacles, it referred to as “the naked eye”).

Based on the aforementioned facts, in the following descriptions, it is assumed that the 3D image can be seen only by using the 3D spectacles (as stereoscopic viewing) and is not capable of being seen without the 3D spectacles (it is difficult to obtain image quality suitable to the watching).

On the contrary, the 2D image includes a single image used for both the left and right eyes. Although a user is not able to see the 2D image as a spectroscopic view even when wearing the 3D spectacles, a user is able to see the 2D image with the naked eye without wearing the 3D spectacles.

On the contrary, the duplex image is basically the same as the 3D image. Similar to the 3D image, the duplex image includes two kinds of images for left and right eyes, and they are alternately displayed. Therefore, a user is able to see the duplex image as stereoscopic viewing similar to the 3D image by wearing the 3D spectacles. However, in the case of the duplex image, the degree of visual protrusion in the image (depth perception) is low due to lower disparity in comparison with the 3D image.

However, in the case of the duplex image, the positional displacement between the left and right images is too small to be recognized by the human eye due to lower disparity between the left-eye and right-eye images in comparison with the 3D image. Therefore, when the duplex image is seen with the naked eye without wearing the 3D spectacles, degradation of visual image quality is rarely recognized by the human eye, and it is seen nearly the same as the 2D image. Of course, in this case, stereoscopic viewing is not provided.

That is, a user is capable of seeing the duplex image as stereoscopic viewing when the duplex image is seen when wearing the 3D spectacles, and a user is capable of seeing the duplex image as a 2D image when the duplex image is seen with the naked eye by taking off the 3D spectacles. In other words, a user may freely wear or remove the 3D spectacles while the user sees the duplex image.

In addition, the 3D image and the duplex image can be distinguished by a disparity level between the left and right images. The threshold value of disparity for distinguishing between both the images may be arbitrarily set if the degradation of visual image quality caused by the disparity is not significantly recognized by user's using the naked eye.

When the 3D imaging apparatus 101 captures an image of the subject and creates the 3D image as described above, the 3D image data are supplied to the image processing apparatus 100.

When the duplex imaging apparatus 102 captures an image of the subject and creates the duplex image as described above, the duplex image data are supplied to the image processing apparatus 100.

When the 2D imaging apparatus 103 captures an image of the subject and creates the 2D image as described above, the 2D image data are supplied to the image processing apparatus 100.

When the image acquisition unit 111 acquires the image data, the image data are supplied to the encoder 112 and the flag creating unit 113.

The encoder 112 encodes the image data supplied from the image acquisition unit 111 based on a predetermined standard such as MPEG(Moving Picture Experts Group)-2, MPEG-4 AVC (Advanced Video Coding)/H.264, or JPEG (Joint Photographic Experts Group) 2000. In this case, the encoder 112 encodes the 2D image, the duplex image, and the 3D image using a corresponding method depending on the standard. In addition, the duplex image is basically processed as the 3D image.

When the encoder 112 creates the image data and creates encoded data, the encoded data are supplied to the flag adding unit 114.

The flag creating unit 113 determines whether the image data supplied from the image acquisition unit 111 correspond to the 3D image, the duplex image, or the 2D image and creates a flag representing the determination result. That is, the flag creating unit 113 creates a flag representing the type of the image data obtained by the image acquisition unit 111 (the image data correspond to which one of the 3D image, the duplex image, or the 2D image). A method of determining the type of the image data is arbitrarily set. For example, the flag creating unit 113 may determine the type of the image data by analyzing the image data supplied from image acquisition unit 111. In addition, the image acquisition unit 111 may supply the flag creating unit 113 with information representing from which the image data are obtained among the 3D imaging apparatus 101, the duplex image apparatus 102, and the 2D imaging apparatus 103, and the flag creating unit 113 may determine the type of the image data based on the information representing the supply source of the image data.

In addition, different kinds of a plurality of image data may be put together into a single one. For example, the image acquisition unit 111 may combine (or concatenate) the 3D image data supplied from the 3D imaging apparatus 101, the duplex image data supplied from the duplex imaging apparatus 102, and the 2D image data supplied from the 2D imaging apparatus 103 into a single clip.

The Clip represents a set of frame images. In the aforementioned example, while each of the 3D image data supplied from the 3D imaging apparatus 101, the duplex image data supplied from the duplex imaging apparatus 102, and the 2D image data supplied from the 2D imaging apparatus 103 is a single clip, they are combined into a single clip (a set of the frame images) by the image acquisition unit 111.

Since the clip may be include a plurality of image data as described above, a single clip may include the 3D image in any scene, the duplex image in another scene, and the 2D image in still another scene.

In this case, the flag creating unit 113 determines the types of all image data and creates flags of all image data. That is, the flag creating unit 113 creates the flag such that which scene or frame corresponds to which type can be identified. A method of representing which flag corresponds to which position (such as a scene or a frame) may be arbitrarily set. For example, each flag may be described by being matched with identification information of the scene, the frame, or the like. In addition, table information representing a matching relationship between each flag and such identification information may be created. Furthermore, scenes, frames, or the like corresponding to each flag may be represented based on the positions added to each flag by the flag adding unit 114.

The flag creating unit 113 supplies the flag adding unit 114 with the created flag.

The flag adding unit 114 adds the flag supplied from the flag creating unit 113 to the encoded data supplied from the encoder 112. The position for adding the flag may be arbitrarily set. For example, the flag adding unit 114 may add the flag to a header of the leading end of the encoded data, a scene header, a picture header, or a block header or embed the flag into a predetermined position of a data part.

The flag adding unit 114 supplies the communication unit 115 and the recording unit 116 with the encoded data obtained by adding the flag.

The communication unit 115 is a communication interface for executing communication with other devices via a network 104 which includes any communication network such as a LAN or the Internet. The communication unit 115 transmits the encoded data supplied from the flag adding unit 114 to other devices via a network 104. In addition, the network 104 also includes a cable used to directly connect each device such as a universal serial bus (USB) cable. In addition, the network 104 also includes a radio communication network as well as a wired communication network. Furthermore, the network 104 may include a plurality of types of communication networks, for example, including a wired communication network and a radio communication network.

The recording unit 116 is a drive corresponding to a removable medium 105 such as an optical disc, a magneto-optical disc, a magnetic disc, or a semiconductor memory.

The recording unit 116 writes and records the encoded data supplied from the flag adding unit 114 into the removable medium 105 installed in a predetermined position thereof. The removable medium 105 is basically installed in other devices to read the recorded encoded data as necessary.

The encoded data with the flag being added are output to an external side of the image processing apparatus 100 by the communication unit 115 or the recording unit 116 through the network 104 or the removable medium 105.

That is, the image processing apparatus 100 adds the flag corresponding to the type of the image to the image data supplied from an external side and outputs (transmits) the image data (to other devices).

In this case, the image processing apparatus 100 creates information capable of identifying the duplex image as well as the 3D image and the 2D image as the flag and adds the information to the image data (encoded data). That is, the image processing apparatus 100 may add a flag capable of identifying the duplex image, which was difficult in the devices of the related art. Therefore, the image processing apparatus 100 can execute processing suitable to the characteristics of the image. In other words, the image processing apparatus 100 may process the image data (encoded data) with the flag being added and allow an image processing apparatus that executes image display or the like to identify the duplex image. That is, the image processing apparatus 100 may allow an image processing apparatus that executes image data (encoded data) with the flag being added to execute processing suitable to the characteristics of the image.

In addition, the image acquisition unit 111 may obtain image data from devices other than any of the imaging apparatuses described above.

However, while the duplex imaging apparatus 102 for creating the duplex image may create the duplex image using any arbitrary method, two detailed examples of the duplex imaging apparatus 102 will be provided in the following descriptions.

Duplex Imaging Apparatus

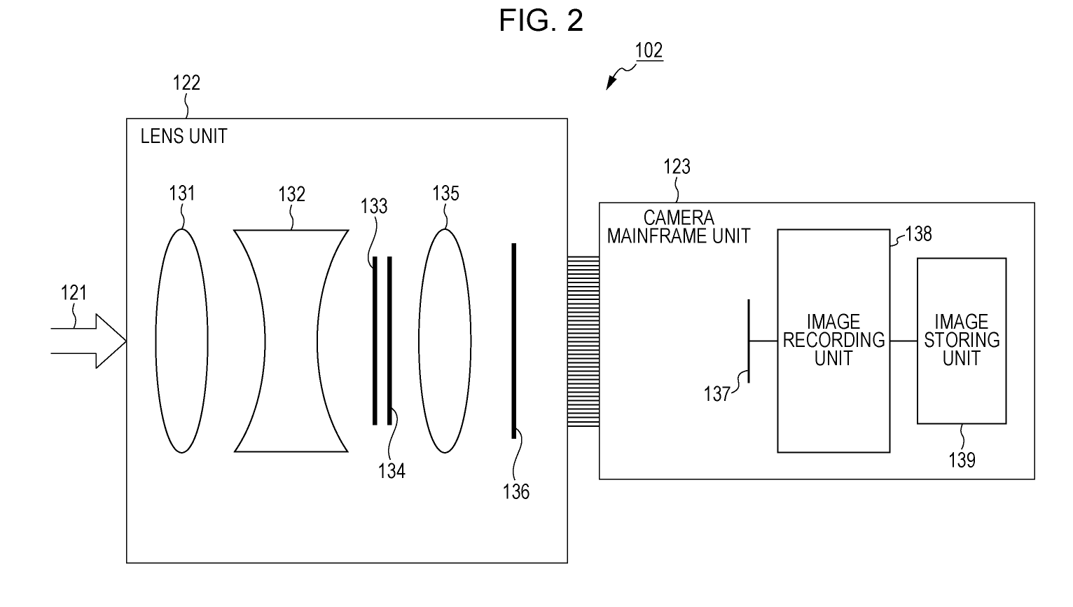

FIG. 2 is a top cross-sectional view illustrating an example of the duplex imaging apparatus 102 of FIG. 1. The duplex imaging apparatus 102 receives the incident light 121 from the subject, divides it into left and right parts using the polarization filter 134, and focuses them on the imaging element 137 to create left and right image data. The imaging apparatus includes a lens unit 122 in the front stage of a camera mainframe unit 123.

The lens unit 122 includes image capture lenses 131 and 132, an aperture 133, a polarization filter 134, and an imaging lens 135.

The image capture lenses 131 and 132 are used to collect the incident light 121 from the subject. The image capture lens 131 or the like includes a focus lens used for focusing or a zoom lens for magnifying the subject and is generally realized through the combination of a plurality of lenses for correcting color aberration or the like.

The aperture 133 has a function of narrowing its diameter to adjust the amount of the light collected. The aperture 133 is generally configured by combining a plurality of blades having a plate shape. At the position of the aperture 133, the light diffused from a single point on the subject becomes parallel light.

The polarization filter 134 divides the collected light into two different polarizations. The polarization filter 134 is divided into bilaterally symmetric polarizers as described below to generate linearly-polarized light in which light beams are perpendicularly polarized or circularly-polarized light in which light beams are reversely polarized at the left and right positions with respect to the erected state of the camera. The polarization filter 134 is arranged in proximity of and in parallel with the aperture 133. That is, the polarization filter 134 has a function of dividing light into two different kinds of polarized light beams using the bilaterally symmetric polarizer in the area where the light diffused from a single point of the subject becomes parallel light. However, these two different kinds of polarized light beams are incident to the image forming lens 135 and imaged together. In addition, the polarization filter 134 is an example of the dividing unit described in the claims.

The image forming lens 135 is a lens used to focus the light incident from the polarization filter 134. The light focused by the image forming lens 135 is projected to the imaging element 137 of the camera mainframe unit 123.

In this case, the entrance pupil 136 is indicated closer to the camera mainframe unit 123 side than the image forming lens 135.

The camera mainframe unit 123 includes an imaging element 137, an image recording unit 138, and an image storing unit 139. The imaging element 137 is a photoelectric conversion element for photoelectrically converting the light incident from the lens unit 122 into electronic signals. The electronic signals converted by the imaging element 137 form left and right image data. The imaging element 137 is implemented by, for example, a charge coupled devices (CCD) image sensor, a complementary metal oxide semiconductor (CMOS) image sensor, or the like. The image recording unit 138 records the left and right image data output from the imaging element 137 in the image storing unit 139. The image storing unit 139 stores the left and right image data output from the image recording unit 138. In addition, the image recording unit 138 also supplies the left and right image data output from the imaging element 137 to the image processing apparatus 100 as the duplex image data.

Functional Configuration Example of Duplex Imaging Apparatus

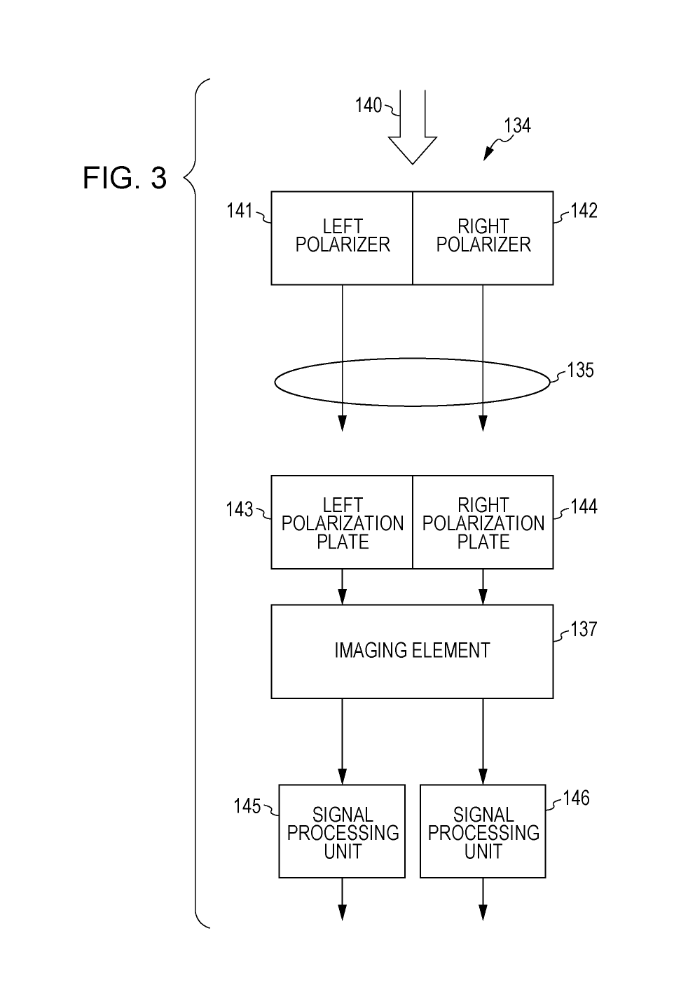

FIG. 3 is a diagram illustrating a functional configuration example of the duplex imaging apparatus 102 of FIG. 1. The light 140 condensed by the image capture lenses 131 and 132 is divided into two different kinds of polarized light beams by the polarization filter 134 at the position where the light becomes approximately parallel. The polarization filter 134 is divided into the left polarizer 141 and the right polarizer 142 to generate linearly-polarized light in which light beams are perpendicularly polarized or circularly-polarized light in which light beams are reversely polarized. The generated light beams are focused together on the surface of the imaging element 137 by the image forming lens 135. In addition, configuration examples of the left polarizer 141 and the right polarizer 142 will be described below.

On the surface of the imaging element 137, every area corresponding to each pixel or each pixel group of the imaging element 137 matches with any of the left polarization plate 143 or the right polarization plate 144. Therefore, the light polarized by the left polarization plate 143 or the right polarization plate 144 is incident to each pixel of the imaging element 137. As a result, any one of the polarized light beams transmits through each area corresponding to the pixel or the pixel group of the imaging element 137 using the left polarization plate 143 or the right polarization plate 144. In addition, the left polarization plate 143 and the right polarization plate 144 are examples of the transmission unit described in the claims. The matching pattern of the left polarization plate 143 and the right polarization plate 144 will be described below.

The electronic signals photoelectrically converted by the imaging element 137 are supplied to the signal processing units 145 and 146. The signal processing unit 145 creates the left-eye image for the left eye for stereoscopic viewing. Meanwhile, the signal processing unit 146 creates the right-eye image for the right eye for stereoscopic viewing.

Configuration Example of Polarization Filter

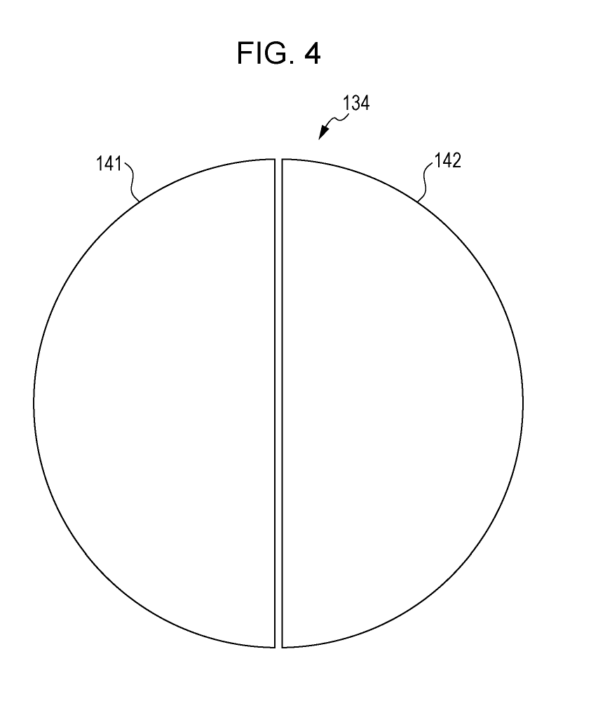

FIG. 4 is a diagram illustrating a configuration example of the polarization filter 134. The polarization filter 134 has a generally disc shape and is divided into the left polarizer 141 and the right polarizer 142 at the center diameter position. That is, the left polarizer 141 and the right polarizer 142 have a bilaterally symmetric structure.

The left polarizer 141 is a filter performing polarization for the image obtained by viewing the subject from the left eye. The right polarizer 142 is a filter performing polarization for the image obtained by viewing the subject from the right eye. The left and right polarizers 141 and 142 generate linearly-polarized light in which light beams are perpendicularly polarized or circularly-polarized light in which light beams are reversely polarized.

Example of Matching Pattern of Polarization Plate

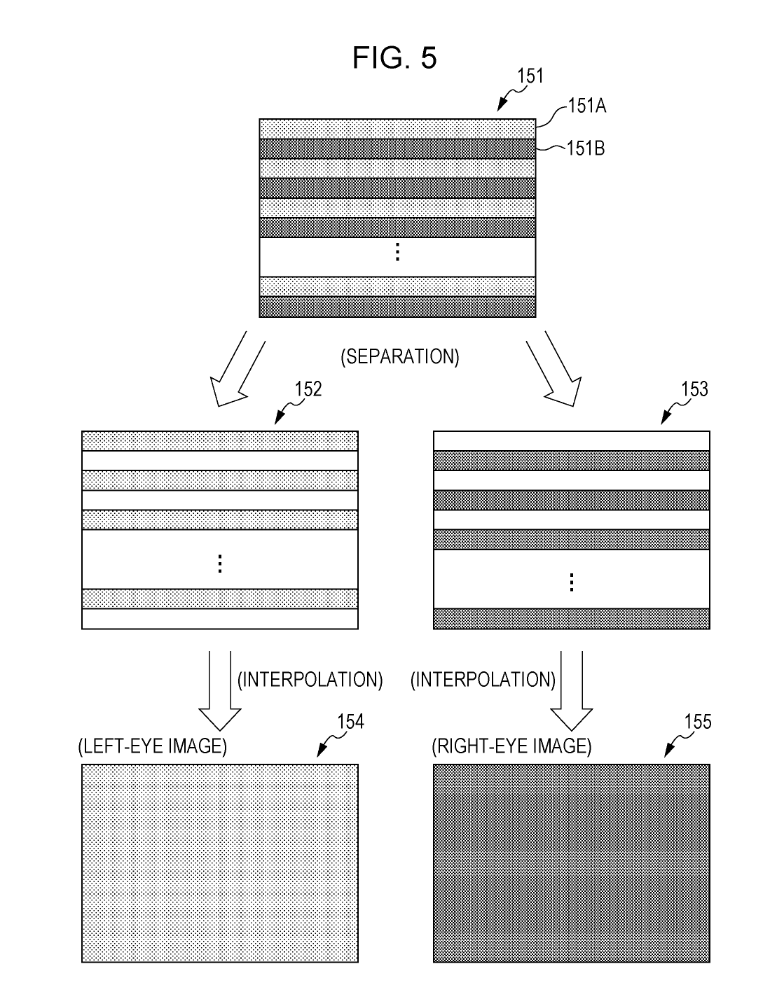

FIG. 5 is a diagram illustrating an example of the matching pattern of the left polarization plate 143 and the right polarization plate 144. In this example, the left polarization plate 143 and the right polarization plate 144 are arranged to transmit the polarized light beams of the same direction through the pixel group consecutively arranged in a horizontal direction on the plane which is the surface of the imaging element 137. For example, in a high vision image 151 including 1080 vertical pixels by 1920 horizontal pixels, polarization plates for performing polarization in different directions are alternately arranged by using a rectangular shape which covers 3840 pixels including 2 vertical pixels by 1920 horizontal pixels as a basis.

Here, the left polarization plate 143 has a polarization characteristic of the same direction as that of the left polarizer 141 and transmits only the light polarized by the left polarizer 141. Similarly, the right polarization plate 144 has a polarization characteristic of the same direction as that of the right polarizer 142, and transmits only the light polarized by the right polarizer 142. Therefore, the imaging element 137 creates an image 151 in which the light beam 151A polarized by the left polarizer 141 and the light beam 151B polarized by the right polarizer 142 are alternately repeated in the column direction.

Based on the image 151 created in this manner, the signal processing units 145 and 146 divides the light into the light polarized by the left polarizer 141 and the light polarized by the right polarizer 142. That is, the signal processing unit 145 creates the image 152 formed by only the light polarized by the left polarizer 141, and the signal processing unit 146 creates the image 153 formed by only the light polarized by the right polarizer 142.

However, the images 152 and 153 have a disengaged state for each other as shown in FIG. 5. Therefore, the signal processing units 145 and 146 execute a de-mosaic process and an interpolation process for the images 152 and 153, respectively, to create the left-eye and right-eye images 154 and 155.

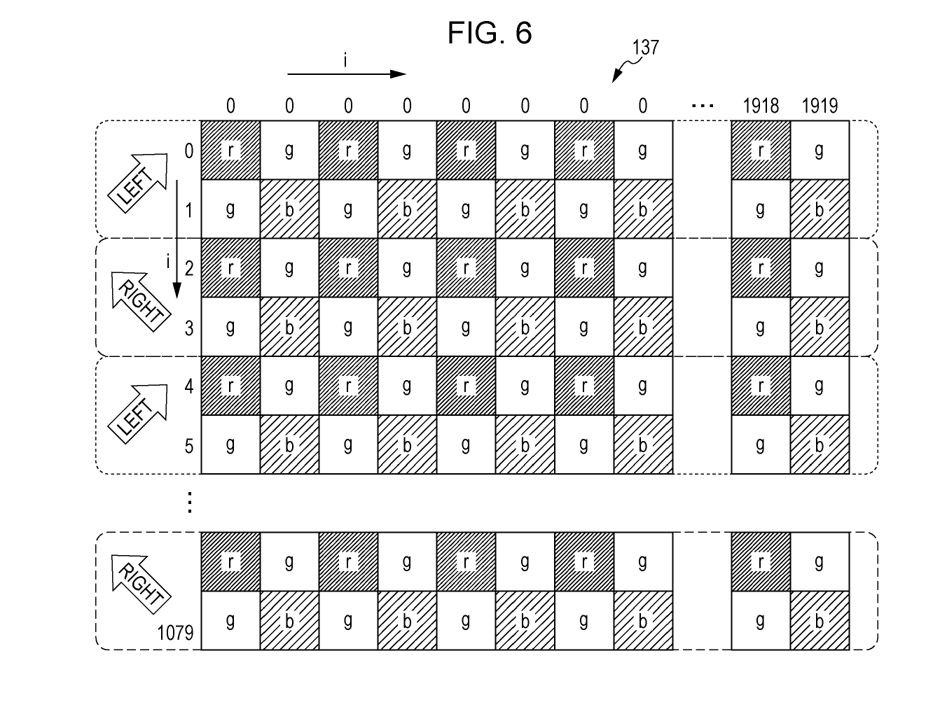

FIG. 6 is a diagram illustrating an example of the relationship between the matching patterns and the pixels of the left polarization plate 143 and the right polarization plate 144. In this example, it is assumed that, in a high vision image including 1080 vertical pixels by 1920 horizontal pixels, polarization plates for performing polarization in different directions are alternately arranged by using a rectangular shape which covers 3840 pixels including 2 vertical pixels by 1920 horizontal pixels as a basis.

In this arrangement, it is assumed that each pixel of the imaging element 137 is arranged as a Bayer arrangement, the horizontal scan lines have the same polarization characteristic, and each pixel group of red, green, and blue colors RGB has the same polarization characteristic.

That is, in consideration of an affinity with portrayal, if the scan lines have the same polarization property, it is reasonable from the viewpoint of human visual characteristics. In addition, in a block including 2 vertical pixels by 2 horizontal pixels, it would be advantageous in de-mosaic and interpolation processes if one pixel is used for the red, one pixel is used for the blue, and two pixels are used for the green.

In this manner, the duplex imaging apparatus 102 may create left and right images by selectively transmitting the light divided into the left and right by the polarization filter 134 through the left polarization plate 143 and the right polarization plate 144 attached on the surface of the imaging element 137 on a two-line basis.

Another Example of Duplex Imaging Apparatus

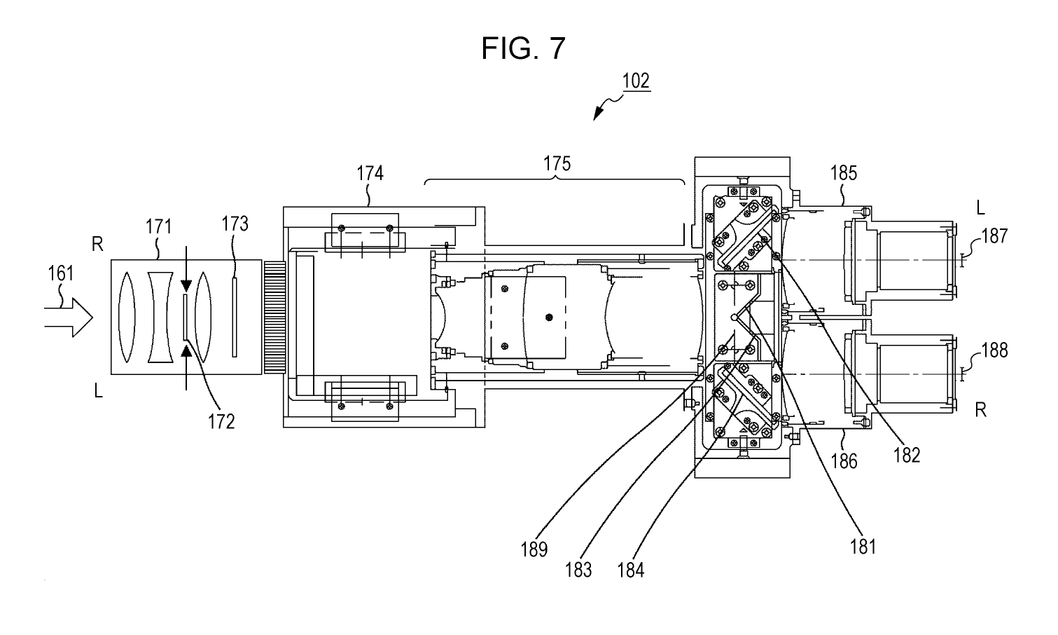

FIG. 7 is a top cross-sectional view illustrating another example of the duplex imaging apparatus 102 of FIG. 1. In this case, the duplex imaging apparatus 102 receives the incident light 161 from the subject and focuses the light on the left and right imaging elements 187 and 188 to create left and right image data. In FIG. 7, the upper half is directed to the right side (R), and the lower half is directed to the left side (L) toward the subject.

In the mainframe of the imaging apparatus, the exchange lens 171 is installed by the lens mount 174. The exchange lens 171 is a lens group for condensing the light 161 incident from the subject and includes an aperture 172 as the exchange lens 171 in addition to the lens group including a focus lens used for focusing, a zoom lens used for magnifying the subject, or the like. In addition, the exchange lens 171 is an example of the image capture lens described in the claims.

The lens mount 174 is used to install the exchange lens 171 in the mainframe of the imaging apparatus. Inside the lens mount 174, the condensed light is focused once, and the inverted image in which the left and the right are inverted.

In the next stage of the lens mount 174, a relay lens unit 175 is arranged. The relay lens unit 175 has a relay lens that transmits the light condensed up to the lens mount 174 to the position of the aperture 189. Using the relay lens, the diffused light from the point light source at the objective focal position becomes the parallel light at the position of the aperture 189.

In the next stage of the relay lens unit 175, the mirrors 181 to 184 are arranged. The mirrors 181 to 184 constitute an optical dividing mirror which is arranged in the position of the aperture 189 and has a function of dividing the condensed light into the left and the right. That is, the light seen from the left side toward the subject is bilaterally inverted and reflected at the mirrors 181 and 182. The light seen from the right side toward the subject is bilaterally inverted and reflected at the mirrors 183 and 184 so that the light is divided into the left and the right.

The positions where the mirrors 181 to 184 are arranged correspond to the area where the diffused light from the point light source at the objective focal position (position of the subject) of the lens mount 174 becomes parallel light so as to appropriately divide the light. In addition, the aperture 189 is an example of the aperture described in the claims.

The light divided by the mirrors 181 to 184 is incident to the image forming lenses 185 and 186. That is, the light, that is seen from the left and divided by the mirrors 181 and 182, is incident to the image forming lens 185, and the light that is seen from the right and divided by the mirrors 183 and 184, is incident to the image forming lens 186. The image forming lenses 185 and 186 focus respective incident light on the light receiving surfaces of the imaging element 187 and 188. Each light incident to the imaging elements 187 and 188 forms an erected image.

The imaging elements 187 and 188 are photoelectric conversion elements for converting the light incident from the image forming lens 185 and 186, respectively, into electronic signals. The imaging elements 187 and 188 are implemented, for example, using CCD or CMOS image sensors.

In this manner, the duplex imaging apparatus 102 receives the incident light 161 from the subject, and the light is divided into the left and the right using the mirrors 181 to 184 so that images corresponding to the left and right image data are formed on the left and right imaging elements 187 and 188.

Optical Path

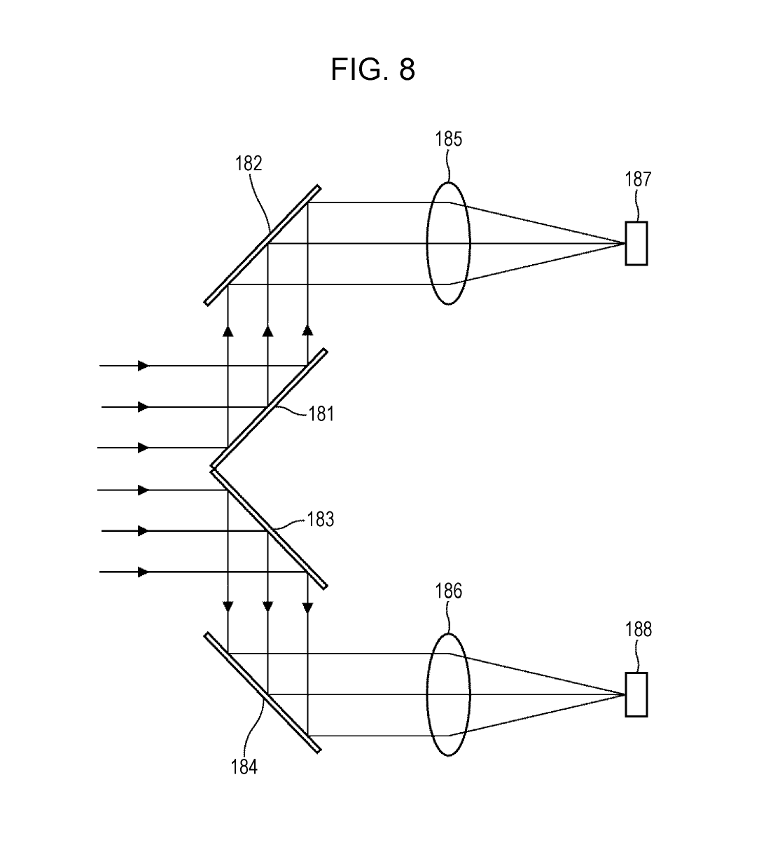

FIG. 8 is a diagram illustrating exemplary main components of the duplex imaging apparatus 102. The light transmitted by the relay lens unit 175 is divided into the left and the right by the mirrors 181 and 183. The light seen from the left toward the subject is reflected at the mirror 181 and further reflected at the mirror 182. The light seen from the right toward the subject is reflected at the mirror 183 and further reflected at the mirror 184. The mirrors 181 to 184 are arranged at the position of the aperture 189, and the incident light becomes parallel light.

The left light reflected at the mirror 182 is incident to the image forming lens 185. The light incident to the image forming lens 185 is focused on the light receiving surface of the imaging element 187. The right light reflected at the mirror 184 is incident to the image forming lens 186. The light incident to the image forming lens 186 is focused on the light receiving surface of the imaging element 188.

For example, the duplex imaging apparatus 102 is implemented as described above to create the duplex image.

Process Flow

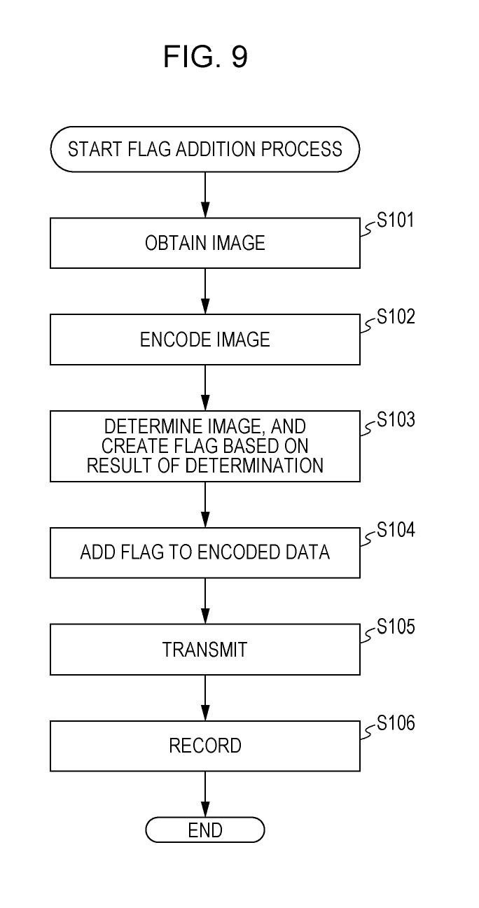

Next, the exemplary flow of the flag addition process executed by the image processing apparatus 100 of FIG. 1 will be described with reference to the flowchart of FIG. 9.

When the flag addition process is initiated, the image acquisition unit 111 of the image processing apparatus 100 obtains an image, for example, from any one of the 3D imaging apparatus 101, the duplex imaging apparatus 102, and the 2D imaging apparatus 103 in step S101.

In step S102, the encoder 112 encodes the image data obtained through step S101 based on a predetermined scheme to create encoded data.

In step S103, the flag creating unit 113 determines the type of the image of the image data obtained through the process of step S101 and creates a flag for identifying the type of the image based on the determination result.

That is, the flag creating unit 113 creates a flag for identifying whether the image corresponds to a 3D image, a duplex image, or a 2D image.

In step S104, the flag addition unit 114 adds the flag created in step S103 to a predetermined position of the encoded data created through step S102.

In step S105, the communication unit 115 transmits the encoded data including the flag added through the process of step S104 to other devices through the network 104.

In step S106, the recording unit 116 records the encoded data including the flag added through the process of step S104 in the removable medium 105.

When the process of step S106 is terminated, the flag addition process is terminated.

Flag

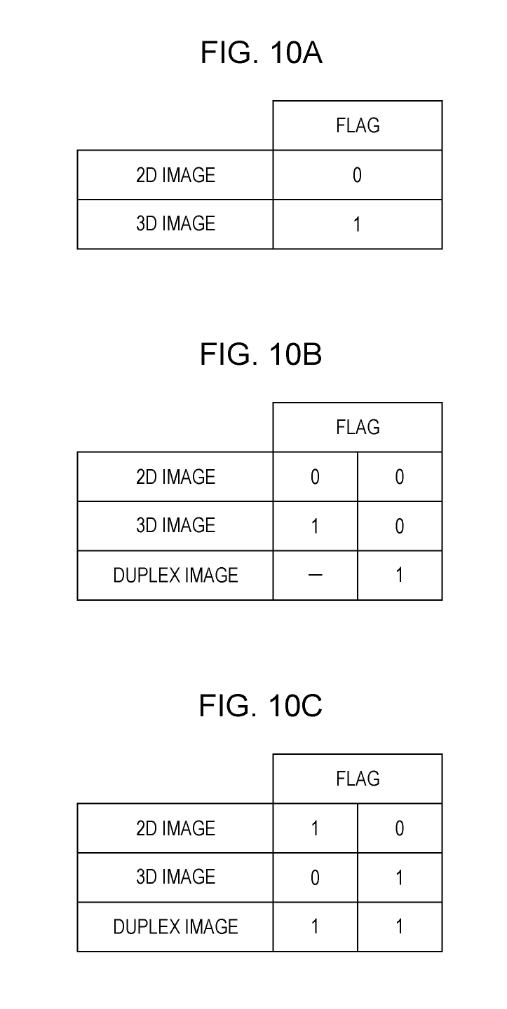

FIGS. 10A to 10C are diagrams illustrating an exemplary flag added to the encoded data.

In the method of the related art, as shown in FIG. 10A, a flag only for identifying the 2D image and the 3D image is added to the encoded data.

The flag creating unit 113 creates a flag of, for example, two bits for also identifying the duplex image. For example, as shown in FIG. 10B, the flag creating unit 113 sets the flag value to “00” in the case of the 2D image, sets the flag value to “10” in the case of the 3D image, and sets the flag value to “−1” (“-” denotes “0” or “1”) in the case of the duplex image.

In this case, the image processing apparatus which processes the flag can readily identify whether or not the image is the duplex image by referencing the less significant bit (one bit in the right side) of the corresponding flag. That is, for example, in the case where a special process is performed only for the duplex image, the image processing apparatus can readily execute the process.

In addition, for example, the flag creating unit 113 may set the flag value to “10” in the case of the 2D image, set the flag value to “01” in the case of the 3D image, and set the flag value to “11” in the case of the duplex image as shown in FIG. 10C.

In this case, the image processing apparatus which processes the corresponding flag can readily identify whether or not the image is capable of stereoscopic viewing by referencing the less significant bit (one bit in the right side) of the flag. That is, for example, in the case where a process for stereoscopic viewing is performed, the image processing apparatus can readily execute the process.

In addition, in this case, the image processing apparatus which processes the corresponding flag can readily identify whether or not the image is an image other than the 3D image is by referencing the more significant bit (one bit in the left side) of the flag. That is, for example, in the case where a process for a user who sees an image with the naked eye without wearing 3D spectacles is performed, the image processing apparatus can readily execute the process.

As described above, the image processing apparatus 100 can identify the duplex image, create a flag corresponding to the duplex image, and add the flag to the image data (encoded data). That is, the image processing apparatus 100 can perform a process suitable to characteristics of the image.

In addition, while it is desired that the image processing apparatus 100 includes both the communication unit 115 and the recording unit 116 in FIG. 1, any one of them may be omitted. In this case, even in the flag addition process described in conjunction with the flowchart of FIG. 9, either of steps S105 or S106 (the process corresponding to the omitted block) may be omitted.

In addition, the encoder 112 may be omitted. In this case, the image processing apparatus 100 outputs baseband image data (including the added flag) that are not encoded. In addition, in the flag addition process shown in FIG. 9, the process of step S102 is omitted.

### 2. Second Embodiment

Configuration of Image Processing Apparatus

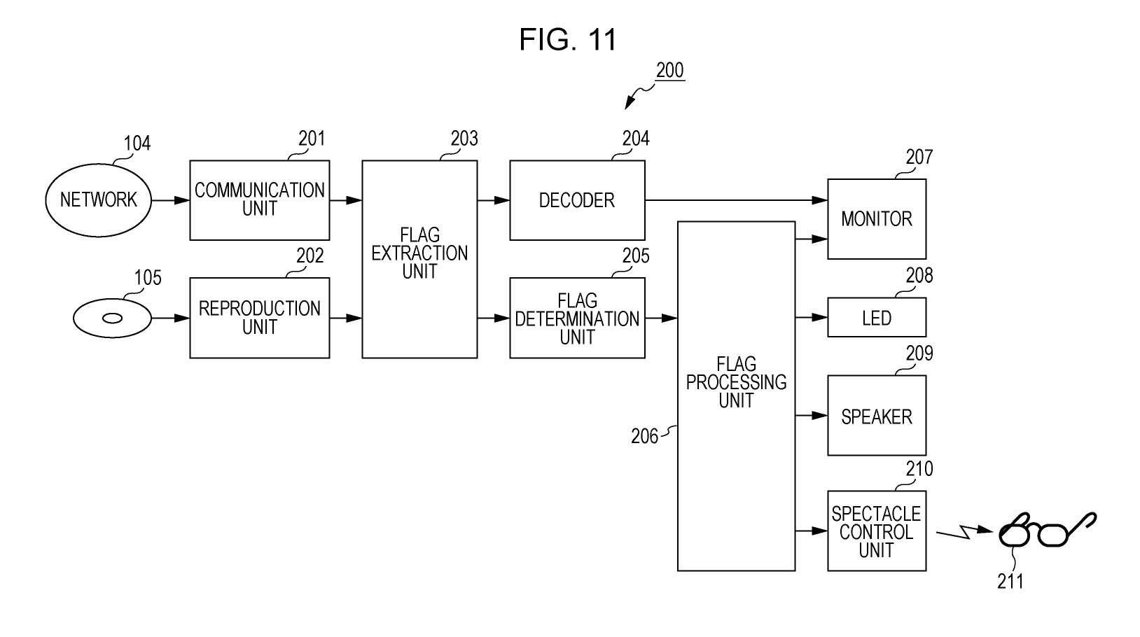

Next, the image processing apparatus which uses the aforementioned flag will be described. FIG. 11 is a block diagram illustrating a main configuration example of the image processing apparatus according to an embodiment of the invention.

The image processing apparatus 200 decodes the encoded data including the flag added by the image processing apparatus 100 of FIG. 1 and reproduces and displays them. In addition, the image processing apparatus 200 performs a process based on the corresponding flag.

The image processing apparatus 200 includes a communication unit 201, a reproduction unit 202, a flag extraction unit 203, a decoder 204, a flag determination unit 205, a flag processing unit 206, a monitor 207, an light emitting diode (LED) 208, a speaker 209, and a spectacle control unit 210.

The communication unit 201 is a communication interface corresponding to the communication unit 115 of the image processing apparatus 100 of FIG. 1 and performs communication with other devices based on a predetermined standard which is the same as that of the communication unit 115. The communication unit 201 receives the encoded data transmitted from the image processing apparatus 100 through the network 104 and supplies the data to the flag extraction unit 203.

The reproduction unit 202 is a drive corresponding to the removable medium 105 and reads information from the removable medium 105 installed in a predetermined position of itself. The reproduction unit 202 reads the encoded data written to the removable medium 105 by the recording unit 116 of the image processing apparatus 100 of FIG. 1 and supplies them to the flag extraction unit 203.

The flag extraction unit 203 extracts the flag added to the encoded data supplied from the communication unit 201 or the reproduction unit 202. The flag extraction unit 203 supplies the encoded data to the decoder 204 and supplies the extracted flag to the flag determination unit 205.

The decoder 204 decodes the encoded data using a decoding scheme corresponding to the encoding scheme of the encoder 112 of the image processing apparatus 100 of FIG. 1 and creates decoded image data. In the case where the encoding scheme of the encoder 112 is a reversible encoding scheme, the decoder 204 can recover the image data in a state before the encoding.

The decoder 204 supplies the decoded image data to the monitor 207 to display the image (decoded image).

The flag determination unit 205 determines the flag value supplied from the flag extraction unit 203 and specifies the type of the decoded image (whether the decoded image is a 3D image, a duplex image, or a 2D image). In the case where the flag corresponds to a part of the image data, the flag determination unit 205 also specifies the corresponding part. In addition, in the case where a plurality of flags are added, the flag determination unit 205 determines all of the flag values.

That is, the flag determination unit 205 determines all flag values added to the image data and specifies what part (such as a scene or a frame) of the decoded image data corresponds to what image.

The flag determination unit 205 supplies the determination result to the flag processing unit 206.

The flag processing unit 206 performs a process corresponding to the flag value determined by the flag determination unit 205. For example, the flag processing unit 206 displays an image notifying a user of the type of the decoded image on the monitor 207, controls turning the LED set 208 on or off to notify a user of the type of the decoded image, outputs a voice guidance for notifying a user of the type of the decoded image from the speaker 209, or executes notification of the type of the decoded image on the 3D spectacles 211 through the spectacle control unit 210.

In this manner, the image processing apparatus 200 performs a process based on the flag value added to the image data (encoded data). Since the flag added by the image processing apparatus 100 is information that can be used to identify the duplex image as described above, the image processing apparatus 200 can perform a process suitable to characteristics of the image.

Process Flow

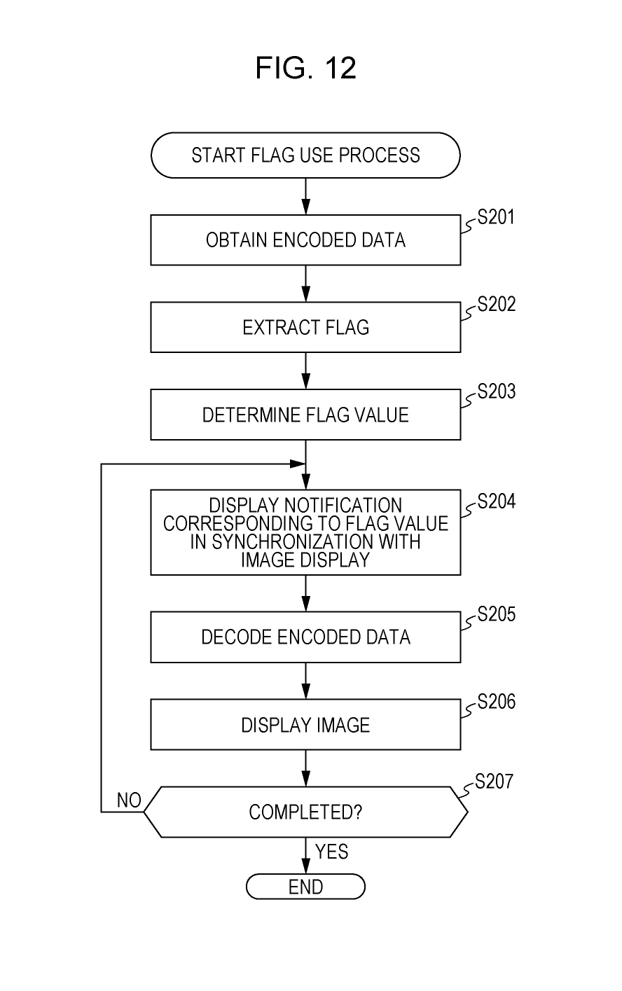

As described above, the image processing apparatus 200 can display an icon for notifying a user of what type of the image is used for the decoded image data on the monitor 207. An example of the flag use process executed by the image processing apparatus 200 for performing such a process will be described with reference to the flowchart of FIG. 12.

When the flag use process is initiated, in step S201, the communication unit 201 or the reproduction unit 202 obtains the encoded data. In step S202, the flag extraction unit 203 extracts the flag added to the encoded data.

In step S203, the flag determination unit 205 determines and specifies the extracted flag value. As described above, the flag determination unit 205 also specifies a matching relationship between the flag values and the frames or the like.

In step S204, the flag processing unit 206 performs notification display corresponding to the flag value in synchronization with the image display. While an example of the notification display will be described below, for example, an icon representing the type of the decoded image (a 3D image, a 2D image, or a duplex image) currently displayed on the monitor 207 is displayed along with the decoded image. A user who watches the decoded image is capable of recognizing the type of the decoded image currently displayed based on the notification by the icon.

In step S205, the decoder 204 decodes the encoded data.

In step S206, the monitor 207 display an image.

In step S207, the flag processing unit 206 determines whether or not the flag use process is to be terminated.

If it is determined that the flag use process is not to be terminated, the process returns to step S204, and the subsequent process is repeated.

In step S207, it is determined that the flag use process is to be terminated, the flag use process is terminated.

That is, until display of the decoded image is terminated, the notification of the type of the decoded image is displayed in synchronization with display of the decoded image.

Notification Display

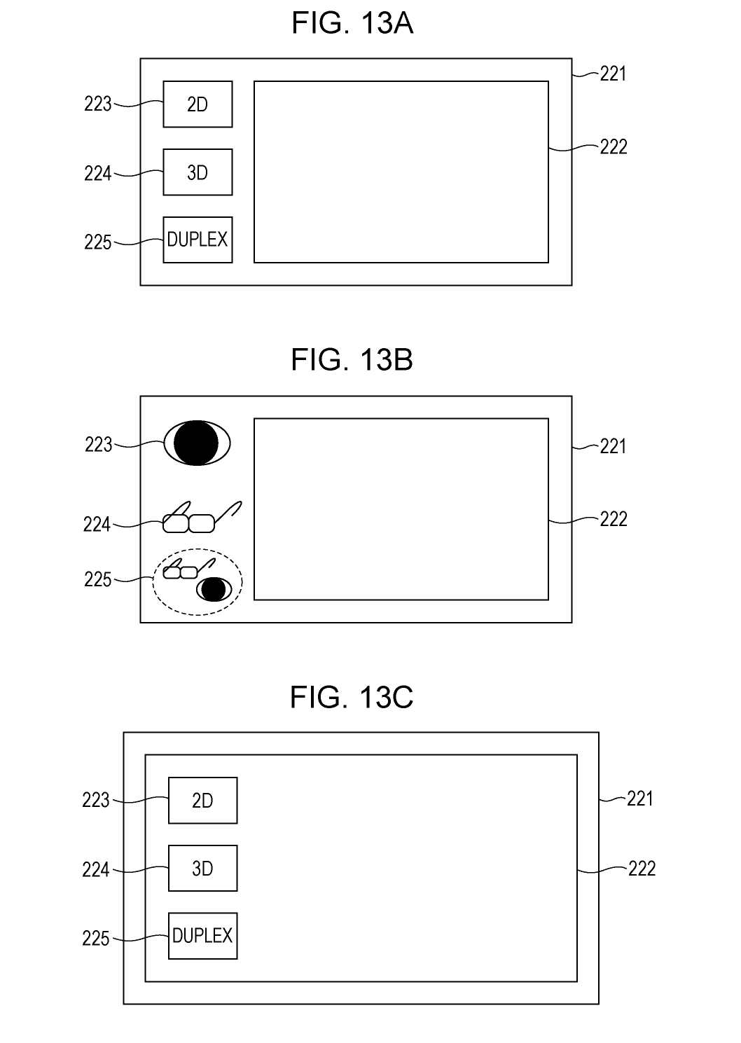

FIGS. 13A to 13C are diagrams illustrating an example of the notification display.

For example, the flag processing unit 206 displays an image display area 222, a 2D icon 223, a 3D icon 224, and a duplex icon 225 on the display screen 221 of the monitor 207 as shown in FIG. 13A.

The image display area 222 is an area for displaying the decoded image. The 2D icon 223 is an image for representing that the decoded image currently displayed on the image display area 222 is the 2D image. The 3D icon 224 is an image for representing that the decoded image currently displayed on the image display area 222 is the 3D image. The duplex icon 225 is an image for representing that the decoded image currently displayed on the image display area 222 is the duplex image.

One of the 2D icon 223, the 3D icon 224, and the duplex icon 225 corresponding to the type of the decoded image displayed on the image display area 222 is displayed. All of the 2D icon 223, the 3D icon 224, and the duplex icon 225 may be displayed, and the icon corresponding to the type of the decoded image displayed on the image display area 222 may be highlighted. For example, the icon corresponding to the type of the decoded image displayed on the image display area 222 may be highlighted by changing the color to be different from other icons, thickening the density in comparison with other icons, increasing luminance in comparison with other icons, thickening the line in comparison with other icons, increasing the size in comparison with other icons, or modifying, moving, or rotating the corresponding icon.

As shown in FIG. 13B, the 2D icon 223, the 3D icon 224, and the duplex icon 225 may have different figures (designs). In the case of FIG. 13B, the 2D icon 223 is designed as an eye that reminds a user of a naked eye (representing that the 3D spectacles 211 are not necessary). The 3D icon 224 is designed as spectacles that reminds a user of 3D spectacles 211 (representing that the 3D spectacles 211 are necessary). The duplex icon 225 is designed as a combination of an eye and spectacles that reminds a user that the 3D spectacles 211 may be installed or may not be installed (representing that characteristics of both the 2D image and the 3D image).

Of course, the 2D icon 223, the 3D icon 224, and the duplex icon 225 may have other figures.

In addition, the display positions of the 2D icon 223, the 3D icon 224, and the duplex icon 225 may be arbitrarily set. For example, any one of the 2D icon 223, the 3D icon 224, and the duplex icon 225 may be selectively displayed on the same position.

In addition, the 2D icon 223, the 3D icon 224, and the duplex icon 225 may be displayed in the upper, lower, or right side of the image display area 222.

For example, as shown in FIG. 13C, the 2D icon 223, the 3D icon 224, and the duplex icon 225 may be overlappingly displaced on the image display area 222 along with the decoded image. In this case, while the 2D icon 223, the 3D icon 224, and the duplex icon 225 can be more readily recognized, they may obstruct watching the decoded image. Therefore, the icon corresponding to the type of the decoded image being displayed may be displayed for a predetermined time period when the type of the image is changed or when an instruction is made from a user, and the icon may not be displayed when the type of the decoded image is not changed.

In this manner, by notifying the type of the image, a user can appropriately select, for example, whether or not the 3D spectacles 211 are used.

For example, as described above, while the 3D spectacles 211 are not necessary in the case of the 2D image, the 3D spectacles 211 are necessary in the case of the 3D image and may be used in the case of the duplex image. In this manner, necessity of the 3D spectacles 211 is changed depending on the type of the image. Since a user can readily recognize what kind of image is currently displayed based on the notification using the aforementioned icons, a user can appropriately select whether or not the 3D spectacles 211 are used and appropriately see the image.

Particularly, when the decoded image is a duplex image, it may be difficult to distinguish between the 2D image and the 3D image.

For example, the type of the image may often be changed from the 2D image to the duplex image in the middle of the clip. In this case, a user sees the image with the naked eye before the change. However, it is difficult to distinguish between the 2D image and the duplex image with the naked eye. That is, a user may not recognize change from the 2D image to the duplex image. Therefore, although stereoscopic viewing can be made by wearing the 3D spectacles 211, a user may continue to watch the image without noticing it. In this case, since a user loses a chance to enjoy the stereoscopic view, user's satisfaction may be degraded.

In addition, for example, the type of the image may be changed from the 3D image to the duplex image in the middle of the clip. In this case, a user sees the image by wearing the 3D spectacles 211 before the change. However, similar to the 3D image, the stereoscopic viewing can be made in the duplex image by wearing the 3D spectacles 211. That is, a user may fail to notice the change from the 3D image to the duplex image. Therefore, although the image can be seen with the naked eye without wearing the 3D spectacles 211, a user may fail to notice it and continue to watch the image with the 3D spectacles 211.

In general, when the 2D image is seen as stereoscopic viewing by wearing the 3D spectacles 211, eyes experience a lot of burdens and may be easily fatigued in comparison with the case where the 2D image is seen by the naked eye. Therefore, it is contemplated a watching method that only the 3D image part that is difficult to recognize with the naked eye is seen by wearing the 3D spectacles, and the duplex image part is seen with the naked eye without wearing the 3D spectacles. However, in the case where the conversion from the 3D image to the duplex image is not noticed, a user may continue to wear the 3D spectacles 211 and see the image so as to unnecessarily increase fatigues of eyes.

In the image processing apparatus 200, since notification is performed using the aforementioned icons, a user can readily select whether or not the 3D spectacles 211 are used and can appropriately see the image.

Notification Using LED

In addition, this notification may be performed outside the display screen 221. For example, the image processing apparatus 200 may perform the notification by turning an LED set 208 on or off for notification display.

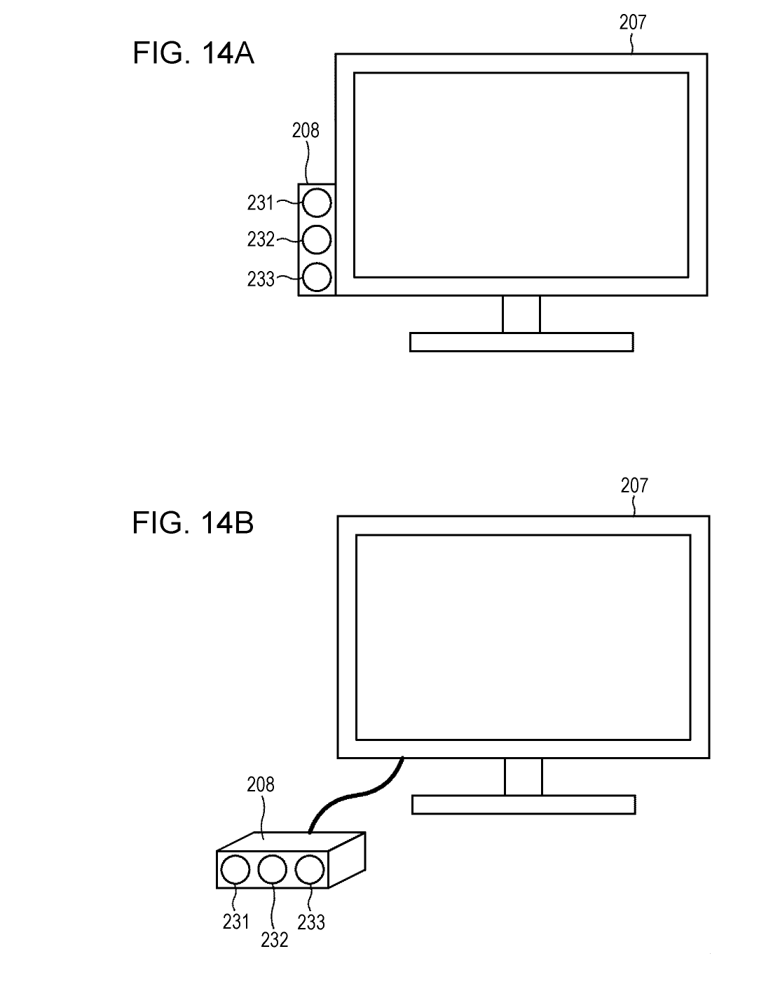

FIGS. 14A and 14B are diagrams illustrating a configuration example of an image type notification LED set. As shown in FIG. 14A, the LED set 208 is installed in the monitor 207. The LED set 208 includes an LED 231 for notifying that the decoded image currently displayed on the monitor 207 is a 2D image, an LED 232 for notifying that the decoded image currently displayed on the monitor 207 is a 3D image, and an LED 233 for notifying that the decoded image currently displayed on the monitor 207 is a duplex image.

That is, the flag processing unit 206 controls the LED set 208 to turn on the LED 231 when the decoded image currently displayed on the monitor 207 is a 2D image, turn on the LED 232 when the decoded image currently displayed on the monitor 207 is a 3D image, and turn on the LED 233 when the decoded image currently displayed on the monitor 207 is a duplex image.

In this manner, similar to the notification using the icons, a user can readily recognize the type of the decoded image currently displayed on the monitor 207.

In addition, the configuration of the LED set 208 may be arbitrarily set. For example, the LEDs 231 to 233 may be turned off. Furthermore, the LEDs 231 to 233 may emit different colors. Moreover, the shapes, sizes, numbers, and arrangement positions of the LEDs 231 to 233 may also be arbitrarily set.

As shown in FIG. 14B, the LED set 208 may be separately provided from the monitor 207. In addition, for example, the LED set 208 may be detachably installed in the monitor 207.

Notification Using Image Display Area

The aforementioned notification of the type of the image may be performed by changing the size of the image display area 222.

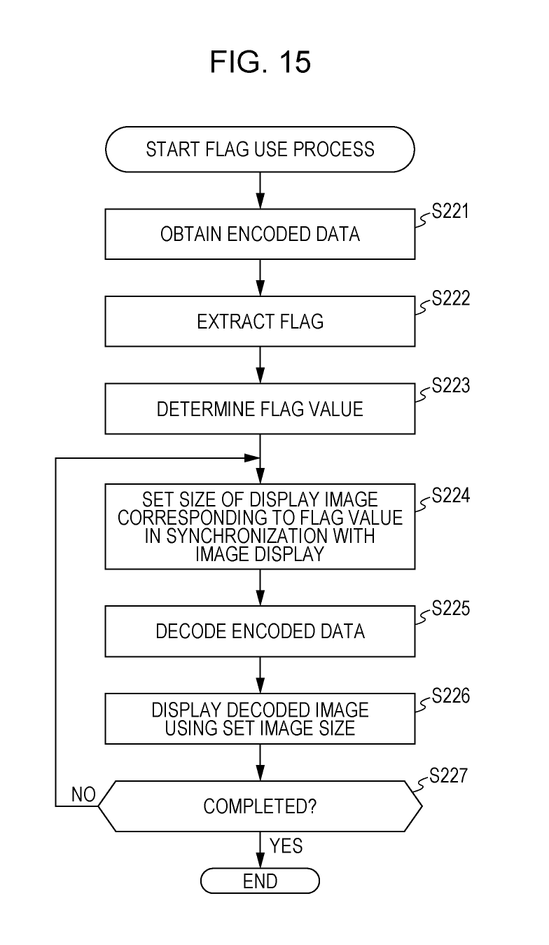

An exemplary flow of the flag use process in this case will be described with reference to the flowchart of FIG. 15. The process in this case is basically performed as described above in conjunction with the flowchart of FIG. 12.

When the flag use process is initiated, each process of steps S221 to S223 is executed as described in each process of steps S201 to S203 of FIG. 12.

In step S224, the flag processing unit 206 sets the display image size corresponding to the flag value in synchronization with image display.

In step S225, the decoder 204 decodes the encoded data. In step S226, the monitor 207 display the image using the set image size.

In step S227, the flag processing unit 206 determines whether or not the flag use process is to be terminated. If it is determined that the flag use process is not to be terminated, the process returns to step S224, and the subsequent process is repeated.

In step S227, if it is determined that the flag use process is to be terminated, the flag use process is terminated.

That is, until the display of the decoded image is terminated, the notification display regarding the type of the decoded image using the display image size is performed in synchronization with display of the decoded image.

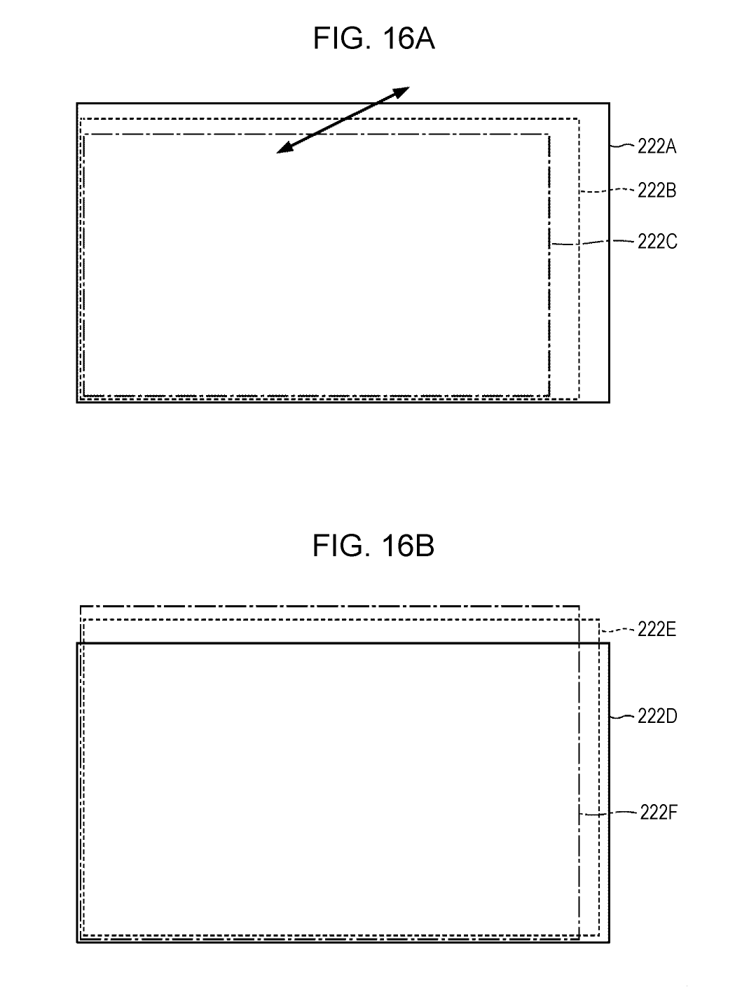

FIGS. 16A and 16B are diagrams illustrating an example of appearance of modification of the image display size.

In the case of FIG. 16A, the size of the image display area 222 is the largest size when the 2D image is displayed as shown in the image display area 222A, becomes a medium size when the duplex image is displayed as shown in the image display area 222B, and becomes the smallest size when the 3D image is displayed as shown in the image display area 222C. The picture size of the decoded image displayed on the image display area 222 is adjusted depending on the image display area 222. That is, the picture size of the decoded image displayed on the monitor 207 is changed depending on the type of the image.

The flag processing unit 206 performs control to change the size of the image display area 222, for example, as shown in FIG. 16A.

As a result, a user who sees the decoded image can readily recognize the type of the decoded image currently displayed based on the picture size (the size of the image display area 222) or the change of the picture size.

In addition, the size ratio of the image display areas 222A to 222C is arbitrarily set.

In addition, while the picture sizes of image display areas 222A to 222C are compared based on positioning of the lower left corner in the example of FIG. 16A, it does not mean that the lower left corner is used as the reference point to change the picture size. The method of changing the picture size is arbitrarily set. For example, the picture size may be changed by using an arbitrary point such as a center point of the image as a reference point or may be changed without using such a reference point. However, if the position of the image is significantly deviated by changing the picture size, it becomes hard to see the image. Therefore, it is preferable that the display position of the image is not moved as long as possible.

Furthermore, which size is allocated to which type of the image is arbitrarily set. In addition, the picture size may be changed, for example, by changing the aspect ratio as shown in FIG. 16B as well as magnitude.

In the case of FIG. 16B, the aspect ratio of the image display area 222 becomes horizontally longest as shown as image display area 222D when the 2D image is displayed, becomes a medium aspect ratio as shown as the image display area 222E when the duplex image is displayed, and becomes vertically longest as shown as the image display area 222F when the 3D image is displayed. The aspect ratio of the decoded image displayed on the image display area 222 is adjusted depending on the image display area 222. That is, the aspect ratio of the decoded image displayed on the monitor 207 is changed depending on the type of the image.

Needless to say, even in the case of the aspect ratio, similar to the case of the picture size, the reference point may be provided or not.

In addition, both the picture size and the aspect ratio may be changed depending on change of the type of the image.

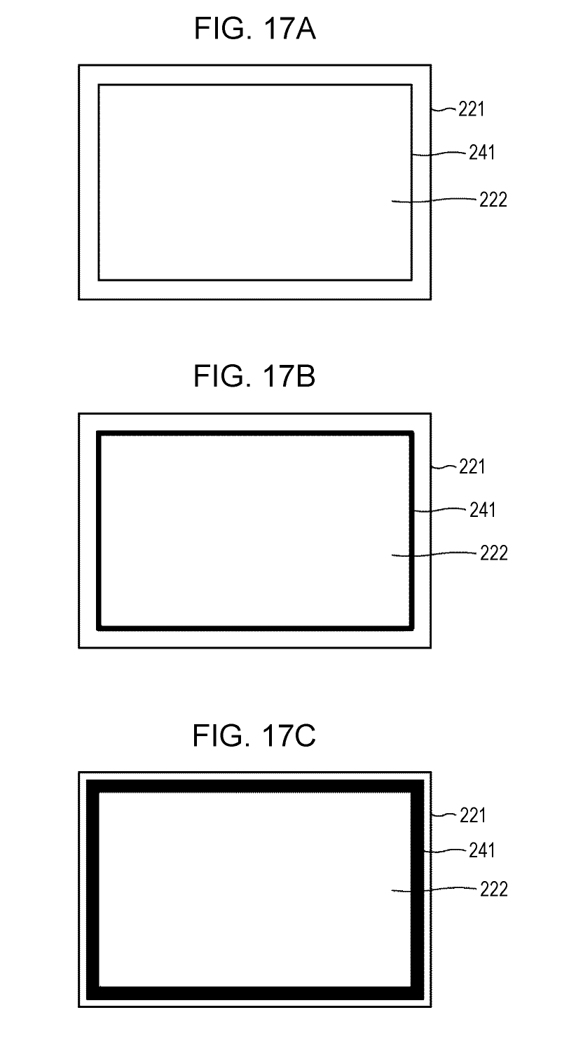

Furthermore, as shown in FIGS. 17A to 17C, the change of the type of the image may be represented by changing the thickness of the image frame of the image display area 222.

For example, the image frame 241 of the image display area 222 may be the thinnest as shown in FIG. 17A when the 2D image is displayed, be medium as shown in FIG. 17B when the duplex image is displayed, and be the thickest as shown in FIG. 17C when the 3D image is displayed.

In each case, the thickness degree of the image frame 241 is arbitrarily set. In addition, the order of thickness of the image frame 241 in each case is also arbitrarily set, and the image frame 241 in any case of the image may be the thickest.

In addition, instead of the size of the image frame 241, the color, density, luminance, texture, or the like of the image frame 241 may be changed depending on the type of the displayed image. Of course, a plurality of parameters may be combined. For example, the thickness, color, and shape of the image frame 241 may be changed depending on the type of the displayed image.

Furthermore, the change of the picture size, the change of the aspect ratio, and the change of the image frame 241 described above may be combined.

Moreover, notification of the type of the decoded image may be performed using methods other than display. For example, a voice guidance notifying a user of the type of the image may be output from the speaker 209. The notification may be performed using vibration instead of the voice.

Notification Using 3D Spectacles

The notification of the type of the decoded image described above is not necessarily performed by the image processing apparatus 200, but may be performed, for example, using the 3D spectacles 211. In this case, the flag processing unit 206 may perform notification using the 3D spectacles 211 used by a user through the spectacle control unit 210.

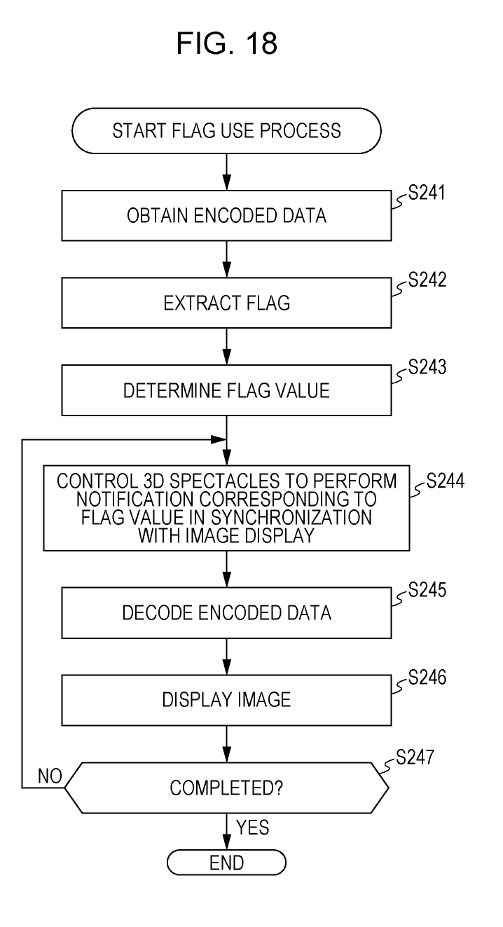

An exemplary flow of the flag use process in this case will be described with reference to the flowchart of FIG. 18. Even in this case, a description will be made similar to the description of the flowchart of FIG. 12.

When the flag use process is initiated, each process of steps S241 to S243 is executed similar to each process of steps S201 to S203 of FIG. 12.

In step S244, the flag processing unit 206 controls the 3D spectacles 211 through the spectacle control unit 210 such that notification corresponding to the flag value can be made in synchronization with image display.

In step S245, the decoder 204 decodes the encoded data. In step S246, the monitor 207 displays the decoded image.

In step S247, the flag processing unit 206 determines whether or not the flag use process is to be terminated.

If it is determined that the flag use process is not to be terminated, the process returns to step S244, and the subsequent process is repeated.

In step S247, if it is determined that the flag use process is to be terminated, the flag use process is terminated.

That is, until the display of the decoded image is terminated, notification of the type of the decoded image using the 3D spectacles 211 is performed in synchronization with display of the decoded image.

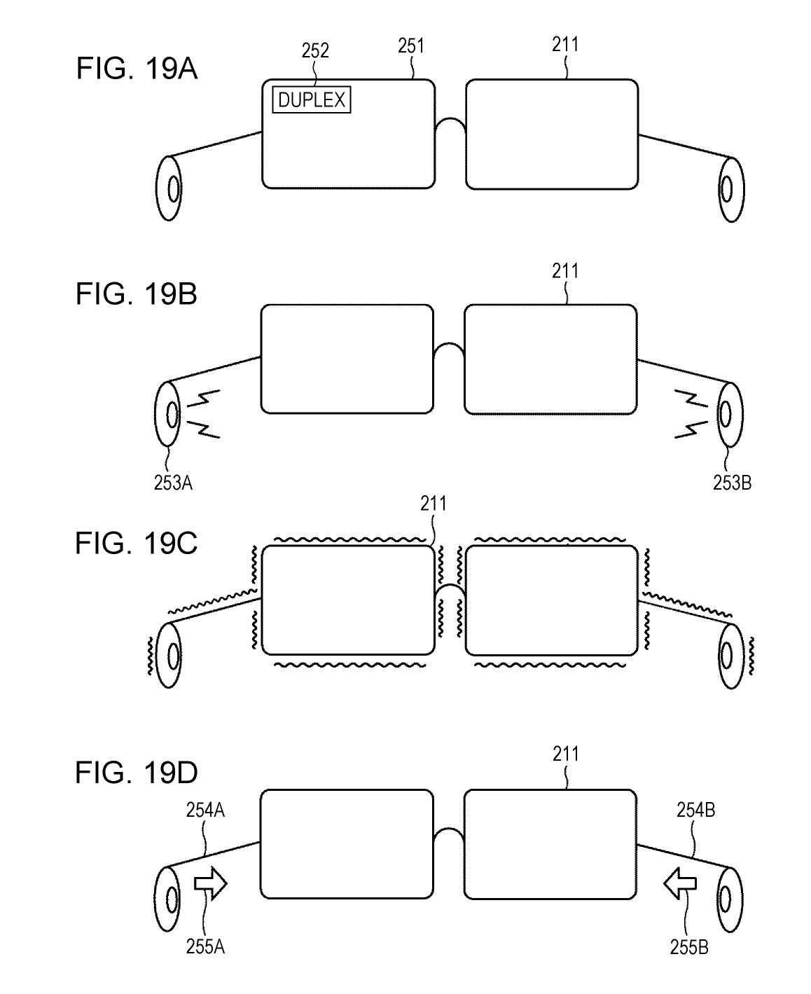

A method of notification using the 3D spectacles 211 is arbitrarily set. An example of the notification method is shown in FIGS. 19A to 19D.

For example, similar to the example of FIGS. 13A to 13C, an icon representing the type of the image may be displayed on the display unit 251 of the 3D spectacles 211 as shown in FIG. 19A. In the case of the example of FIG. 19A, a duplex icon 252 representing that the image currently displayed in the upper left portion of the left-eye display unit 251 is a duplex image is displayed in the 3D spectacles 211.

In addition, similar to the case of the example of FIGS. 13A to 13C, various methods may be applied. The icon may be displayed on the right-eye display unit or both the left-eye and right-eye display units.

In addition, similar to the case of the example of FIGS. 14A and 14B, an LED set for notifying a user of the type of the image, similar to the LED set 208, may be provided in the 3D spectacles 211.

In addition, similar to the example shown in FIGS. 16A and 16B, the picture size or the aspect ratio may be changed depending on the type of the image. Similar to the example shown in FIGS. 17A to 17C, the thickness of the image frame may be changed depending on the type of the image.

As shown in FIG. 19B, a voice guidance as notification of the type of the image currently displayed or the change of the type thereof may be output from the speakers 253A and 253B provided in the 3D spectacles 211.

As shown in FIG. 19C, a vibrator may be provided in the 3D spectacles 211 and may vibrate the 3D spectacles 211 by driving the vibrator when the type of the image is changed. The vibration pattern may be changed based on the type of the image after the change.

As shown in FIG. 19D, the hanger portions 254A and 254B of the 3D spectacles 211 may be tightened inwardly as shown in the arrows 255A and 255B when the type of the image is changed so as to pressure a user's face who wears the 3D spectacles 211.

Of course, other methods may be used to perform notification to a user using the 3D spectacles 211.

Asynchronous Notification

While the type of the displayed decoded image is notified real-timely (instantaneously) in the aforementioned descriptions, the notification of the type of the image may not necessarily be synchronous with display of the decoded image.

For example, the flag processing unit 206 may perform the notification of the type of the decoded image immediately before displaying the decoded image. In this manner, if the notification is previously performed, a user can prepare to see the decoded image, for example, by wearing or getting rid of the 3D spectacles or the like after confirming the notification and before displaying the decoded image corresponding to the notification.

The notification of the type of the image may be performed before starting reproduction display of the clip (display of the decoded image).

For example, the flag processing unit 206 previously stores a notification image (e.g., announcement) for notifying the type of the image in an internal storage unit (not shown). When the communication unit 201 or the reproduction unit 202 obtains the encoded data, the flag extraction unit 203 extracts the flag before the decoding process, and the flag determination unit 205 determines the flag value. In addition, the flag processing unit 206 reads the notification image (e.g., announcement) corresponding to the flag value from the internal storage unit and displays the notification image on the monitor 207.

The flag processing unit 206 controls the monitor 207 to display the notification image in this manner and then starts to display the decoded image. That is, the flag processing unit 206 inserts the notification image for notifying the type of the image included in the clip into the leading end of the clip.

As a result, a user can recognize the type of the image included in the clip before starting reproduction display of the clip.

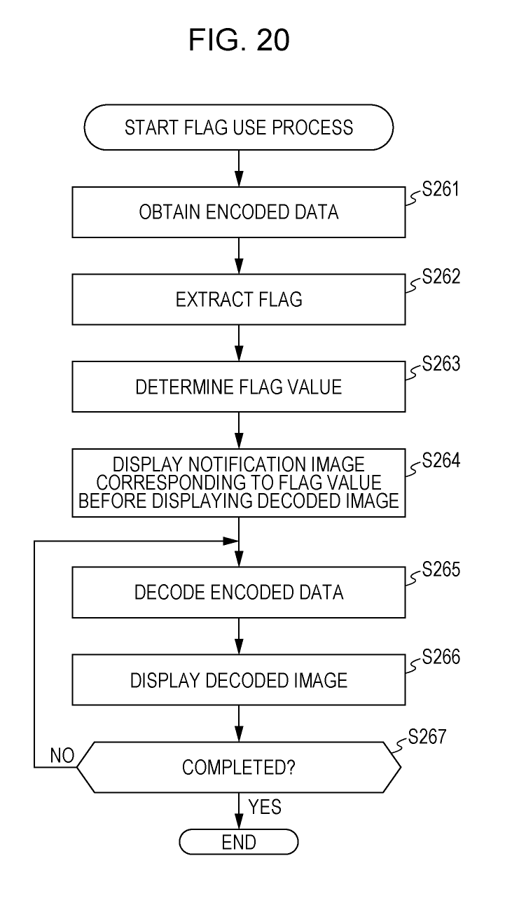

An exemplary flow of the flag use process in this case will be described with reference to the flowchart of FIG. 20. Even in this case, the process is basically performed similar to the description of the flowchart of FIG. 12.

When the flag use process is initiated, each process of steps S261 to S263 is executed similar to each process of steps S201 to S203 of FIG. 12.

In step S264, the flag processing unit 206 displays the notification image corresponding to the flag value before displaying the decoded image.

When display of the notification image is terminated, in step S265, the decoder 204 decodes the encoded data. In step S266, the monitor 207 displays the decoded image.

In step S267, the flag processing unit 206 determines whether or not the flag use process is to be terminated. If it is determined that the flag use process is not to be terminated, the process returns to step S265, and the subsequent process is repeated. That is, the decoded image continues to be displayed until the end of the clip (or until termination is instructed from a user or the like).

In step S267, if it is determined that the flag use process is to be terminated when the end of the clip is reached or when termination is instructed by a user or the like, the flag use process is terminated.

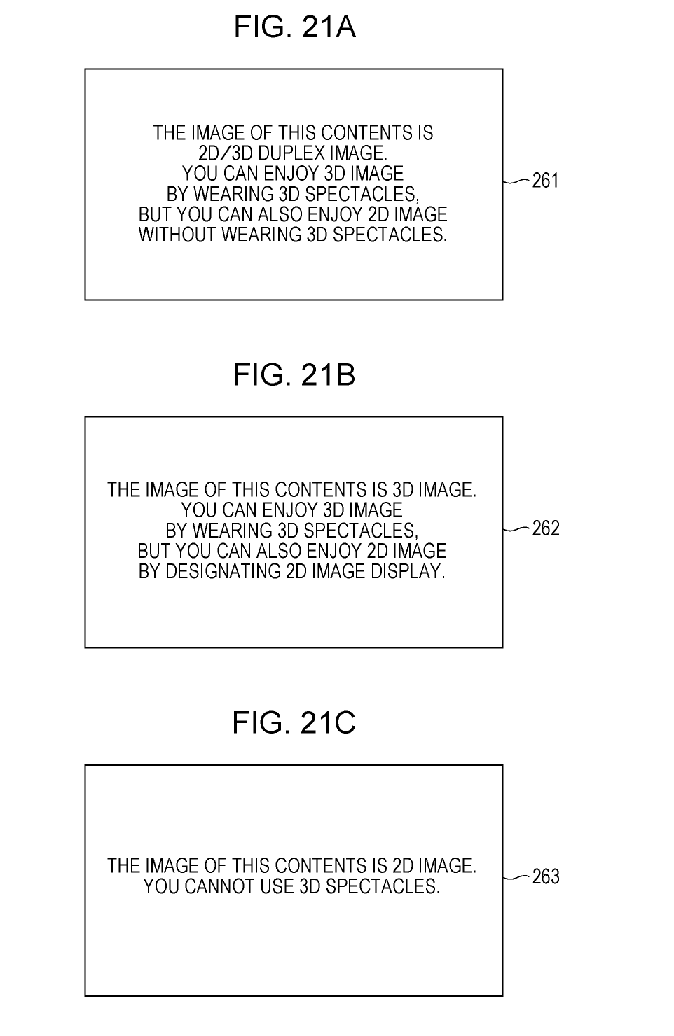

FIGS. 21A to 21C illustrate an exemplary notification image. The notification image 261 shown in FIG. 21A represents that the decoded image is a duplex image. In addition, the notification image 261 also informs a watching method (information on the 3D spectacles 211). As a result, a user can readily select a suitable watching method.

The notification image 262 shown in FIG. 21B represents that the decoded image is a 3D image. In addition, the notification image 262 also informs that the decoded image can be displayed as a 2D image by changing setting. As a result, a user can readily select a suitable watching method.

The notification image 263 shown in FIG. 21C represents that the decoded image is a 2D image. In addition, the notification image 263 also informs that the 3D spectacles 211 are not necessary. As a result, a user can readily select a suitable watching method.

As described above, the image processing apparatus 200 can perform notification of the duplex image as well as notification of the 2D image or the 3D image based on the flag added to the encoded data. That is, the image processing apparatus 200 can perform a suitable process based on the characteristics of the image.

In addition, in the image processing apparatus 200 of FIG. 11, similar to the case of the image processing apparatus 100, either of the communication unit 201 or the reproduction unit 202 may be omitted. In addition, in the case where the image processing apparatus 100 outputs the image data without encoding, the decoder 204 of the image processing apparatus 200 may be omitted.

In addition, the monitor 207, the LED set 208, and the speaker 209 may include devices other than the image processing apparatus 200. In addition, a part of the monitor 207, the LED set 208, and the speaker 209 may be omitted.

Use in Internal Process

While the image processing apparatus 200 uses the flag added to the encoded data in notification of the type of the decoded image in the aforementioned descriptions, the flag may be used in other processes. For example, the image processing executed for the decoded image may be changed depending on the type of the image. For example, in the case where the decoder 204 performs image processing such as image quality adjustment for the decoded image, the flag processing unit 206 may control the image processing depending on the type of the image.

In addition, the flat processing unit 206 may control the decoding method of the decoder 204 depending on the type of the image.

The image processing apparatus 200 may display the image data of the 3D image as the 2D image, for example, based on a user's instruction or the like.

Typically, the decoder 204 decodes each of the two kinds of image data (left-eye and right-eye image data) for the encoded data of the 3D image and decodes one kind of image data (duplex image data for both left-eye and right-eye image data) for the encoded data of the 2D image.

On the contrary, in the case where the image data of the 3D image are displayed as the 2D image as described above, the decoder 204 decodes only predetermined one kind of image data selected from two kinds of image data and displays the decoded image of one kind of the image data is displayed as the 2D image.

However, it is difficult to distinguish between the duplex image and 2D image with the naked eye as described above, In this regard, in the case where it is instructed that the duplex image is displayed as a 2D image, the decoder 204 decodes each of two kinds of image data (left-eye and right-eye image data) and display the image as a 3D image.

That is, when the encoded data correspond to the duplex image, the decoder 204 neglects the instruction of displaying the duplex image as a 2D image. Therefore, the decoder 204 switches the decoding target from the two kinds of image data to any one kind of image data depending on a user's instruction only when the encoded data correspond to the 3D image. When the encoded data correspond to the duplex image, the switching is not performed, but the past decoding process continues.

As a result, the image processing apparatus 200 can suppress disturbance of image display caused by switching the decoding method.

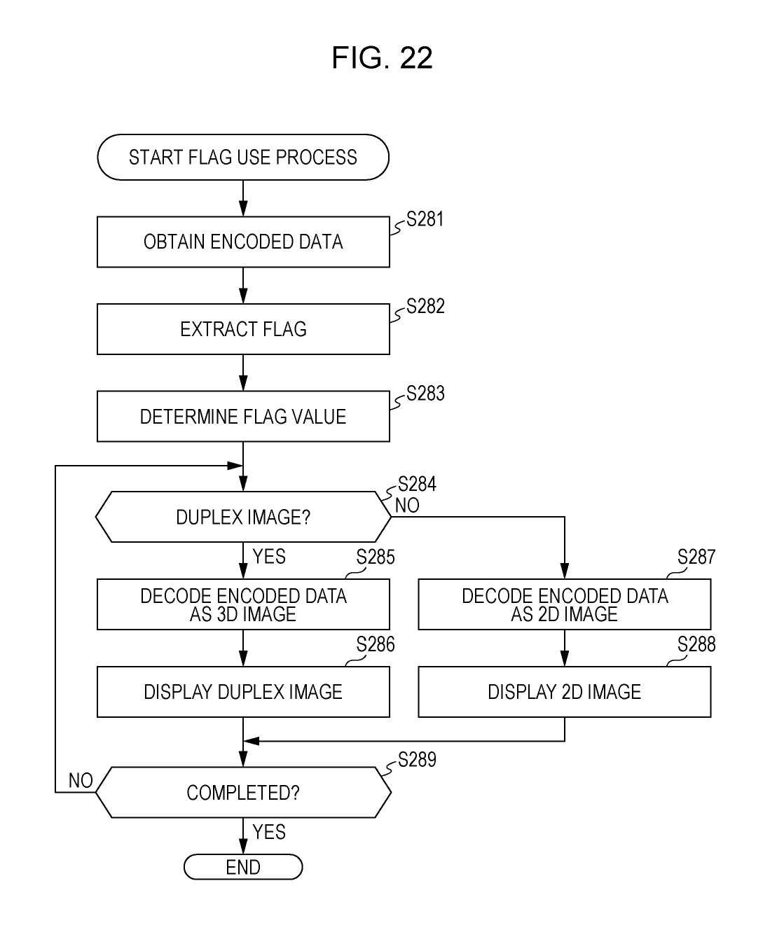

An exemplary flow of the flag use process in this case will be described with reference to the flowchart of FIG. 22.

When the flag use process is initiated, each process of steps S281 to S283 is executed similar to each process of steps S201 to S203 of FIG. 12.

In step S284, the flag processing unit 206 determines whether or not the image of the encoded data is a duplex image. If it is determined that the image of the encoded data is a duplex image, the process advances to step S285.

In step S285, the decoder 204 is controlled by the flag processing unit 206 and decodes the encoded data as the 3D image. That is, two kinds of image data are decoded. In step S286, the monitor 207 displays the decoded image as a duplex image. The duplex image is seen like a 2D image with the naked eye. When the process of step S286 is terminated, the process advances to step S289.

In step S284, if it is determined that the image of the encoded data is not a duplex image, the process advances to step S287. In step S287, the decoder 204 is controlled by the flag processing unit 206 and decodes the encoded data as a 2D image. That is, the decoder 204 decodes only one kind of image data even when the encoded data of the 3D image are used.

In step S288, the monitor 207 displays the decoded image as a 2D image. When the process of step S286 is terminated, the process advances to step S289.

In step S289, the flag processing unit 206 determines whether or not the flag use process is to be terminated.

If it is determined that the flag use process is not to be terminated, the process returns to step S284, and the subsequent process is repeated. That is, the decoding process and display of the decoded image continue until the end of the clip (or until the termination instruction from a user or the like).

In step S289, if it is determined that the flag use process is terminated when the end of the clip is reached or the termination is instructed by a user or the like, the flag use process is terminated.

As described above, the image processing apparatus 200 can neglect a 2D image display instruction for the encoded data of the duplex image based on the flag added to the encoded data. That is, the image processing apparatus 200 can perform a suitable process based on the characteristics of the image.

### 3. Third Embodiment

Configuration of Image Processing System

While the image processing apparatus decodes the encoded data including the added flag and displays the decoded image in the aforementioned description, the method of using the flag may include those other than the aforementioned method, and devices other than the image processing apparatus that decodes the encoded data may use the flag.

For example, the flag may be used in a service of providing (selling or delivering) encoded data as contents.

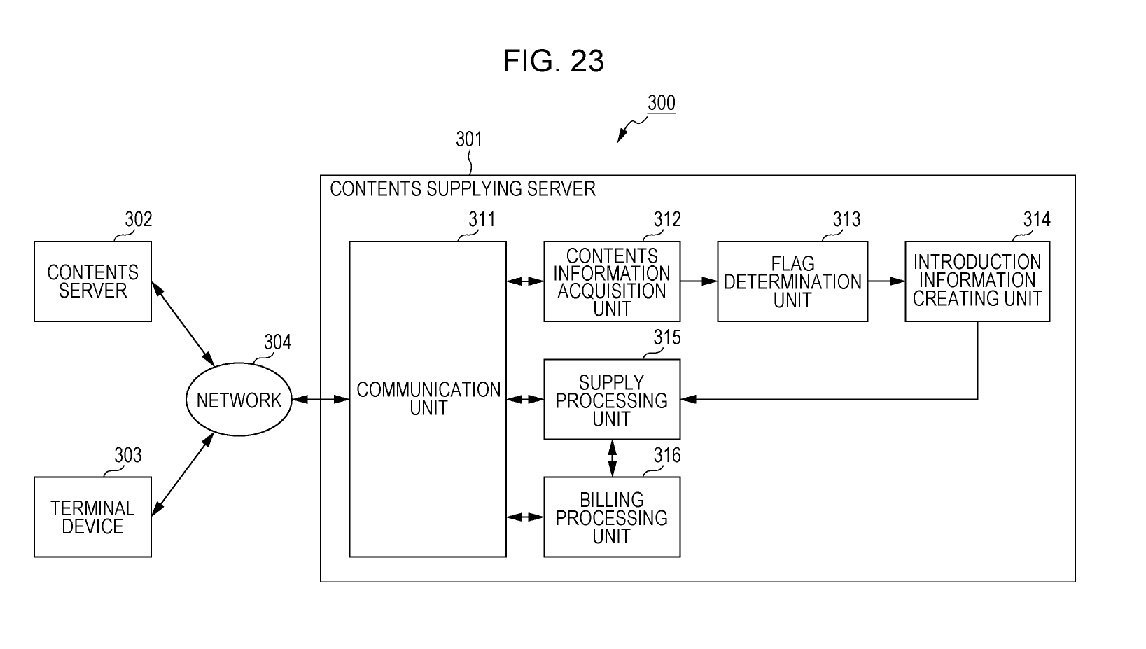

FIG. 23 is a block diagram illustrating a configuration example of the network system according to an embodiment of the invention.

The network system 300 shown in FIG. 23 is a system for performing a service of providing contents. The network system 300 includes a contents supply server 301, a contents server 302, and a terminal device 303. The contents supply server 301, the contents server 302, and the terminal device 303 are connected to communicate with one another via a network 304 which is any communication network such as the Internet. Communication between each device is obtained via the network 304. In the following descriptions, a description thereof will be omitted unless particularly necessary.

The contents supply server 301 provides a service of supplying the terminal device 303 with the contents accumulated in the contents server 302. The contents supply server 301 introduces the contents accumulated in the contents server 302 to the terminal device 303, receives a contents acquisition request from the terminal device 303 and supplies the obtained contents from the contents server 302 to the terminal device 303, or performs a billing process.

The contents supplied to the terminal device 303 are accumulated in the contents server 302. The contents include images or voice. The images of the contents are the 3D image, the 2D image, or the duplex image. Data of the contents (contents data) are encoded by the image processing apparatus 100 of FIG. 1. That is, the contents data are encoded data obtained by encoding the data including the image data using a predetermined scheme, and a flag for identifying the type of the image is added thereto.

The terminal device 303 is a device manipulated by a user who enjoys the contents. The terminal device 303 obtains introduction information (e.g., Web page) of the contents from the contents supply server 301, selects and requests the contents based on the introduction information, and obtains the requested contents from the contents server 302 to watch or listen to the image, the voice, or the like.

That is, the contents supply server 301 obtains the contents information which is information on contents accumulated in the contents server 302 from the contents server 302. The contents supply server 301 creates introduction information of the contents based on the contents information.

When a request is issued by the terminal device 303, the contents supply server 301 supplies the introduction information to the terminal device 303. The terminal device 303 presents the introduction information to a user. A user of the terminal device 303 selects contents to be reproduced based on the introduction information.

The terminal device 303 requests the selected contents to the contents supply server 301. The contents supply server 301 instructs the contents server 302 to transmit the requested contents based on the request. The contents server 302 transmits the encoded data of the requested contents to the terminal device 303.

The terminal device 303 receives the encoded data and decodes them to make a user watch or listen to the image or the voice. In addition, the contents supply server 301 performs a billing process for the aforementioned contents supply.

In the aforementioned service, the contents supply server 301 creates introduction information of the contents suitable to the characteristics of the image based on the flag value included in the contents information obtained from the contents server 302 and supplies the introduction information to the terminal device 303.

The contents information supplied from the contents server 302 to the contents supply server 301 contains all information on the contents and the flag value added to the encoded data.

The contents supply server 301 creates introduction information of the contents suitable to the characteristic of the image using the flag value.

The contents supply server 301 includes a communication unit 311, a contents information acquisition unit 312, a flag determination unit 313, an introduction information creating unit 314, a supply processing unit 315, and a billing processing unit 316.

The communication unit 311 communicates with the contents server 302 and the terminal device 303 through the network 304 according to a predetermined protocol to receive information.

The contents information acquisition unit 312 performs a process of obtaining contents information from the contents server 302 through the communication unit 311. The contents information acquisition unit 312 supplies the obtained contents information to the flag determination unit 313.

The flag determination unit 313 determines the flag value included in the contents information. The flag determination unit 313 supplies the contents information and the determination result of the flag value included in the contents information to the introduction information creating unit 314.

The introduction information creating unit 314 introduces the contents based on the contents information and creates introduction information as a graphical user interface (GUI) for receiving the acquisition request. In this case, the introduction information creating unit 314 includes information representing the type of the image (whether the 3D image, the 2D image, or the duplex image is) of the contents in the introduction information based on the determination result of the flag value.

The introduction information creating unit 314 supplies the created introduction information to the supply processing unit 315.

The supply processing unit 315 performs a process of supplying the contents. The supply processing unit 315 supplies introduction information based on the request from the terminal device 303 through the communication unit 311. For example, when the terminal device 303 accesses a predetermined uniform resource locator (URL), the supply processing unit 315 supplies the introduction information as a Web page corresponding to that URL.

In addition, the supply processing unit 315 performs a process of supplying contents based on the request from the terminal device 303 through the communication unit 311. For example, the supply processing unit 315 receives the contents acquisition request from the terminal device 303 through the communication unit 311 and supplies the request to the contents server 302.

When it is confirmed that the contents is supplied from the contents server 302 to the terminal device 303 based on the aforementioned supply process, the billing processing unit 316 performs a billing process for the contents supply.

Introduction Information

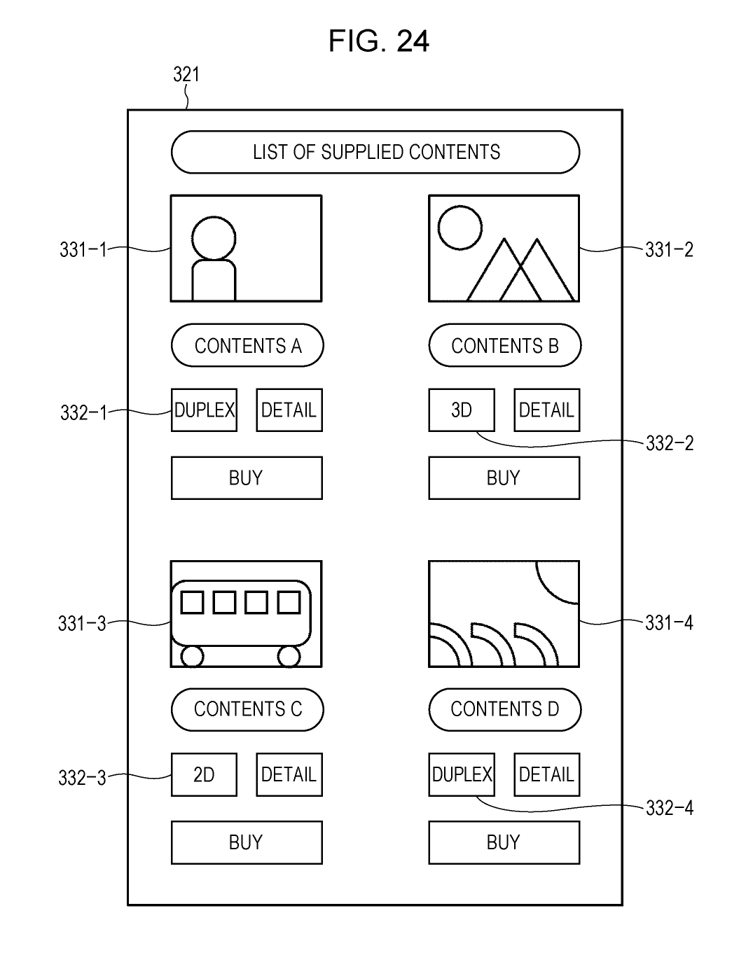

FIG. 24 is a diagram illustrating a display example of the introduction information. The introduction information 321 is, for example, a Web page described using a hyper text markup language (HTML) or the like and displayed on the monitor of the terminal device 303 as an image as shown in FIG. 24.

The introduction information 321 includes a list of the contents that can be supplied (delivered or sold). Each contents includes, for example, a thumbnail image, a title, image type information, a detail display GUI button, and a purchase instruction GUI button.

In the example of FIG. 24, introduction information regarding four contents titled “contents A,” “contents B,” “contents C,” and “contents D” is displayed.

Over display of the title “contents A,” a thumbnail image 331-1 as a representative image for introducing the contents of the “contents A” using an image is displayed. Under the title “contents A,” a detail display GUI button as a GUI button for displaying detailed information on the “contents A” and a duplex icon 332-1 representing that the image of the “contents A” is a duplex image are displayed. Furthermore, a purchase instruction GUI button to be pressed when a user purchases the “contents A” is displayed thereunder.

Similarly, over display of the title “contents B,” a thumbnail image 331-2 as a representative image for introducing the contents of the “contents B” using an image is displayed. Under the title “contents B,” a detail display GUI button as a GUI button for displaying detailed information on the “contents B” and a 3D icon 332-2 representing that the image of the “contents B” is a 3D image are displayed. Furthermore, a purchase instruction GUI button to be pressed when a user purchases the “contents B” is displayed thereunder.

Similarly, over display of the title “contents C,” a thumbnail image 331-3 as a representative image for introducing the contents of the “contents C” using an image is displayed. Under the title “contents C,” a detail display GUI button as a GUI button for displaying detailed information on the “contents C” and a 2D icon 332-3 representing that the image of the “contents C” is a 2D image are displayed. Furthermore, a purchase instruction GUI button to be pressed when a user purchases the “contents C” is displayed thereunder.

Similarly, over display of the title “contents D,” a thumbnail image 331-4 as a representative image for introducing the contents of the “contents D” using an image is displayed. Under the title “contents D,” a detail display GUI button as a GUI button for displaying detailed information on the “contents D” and a duplex icon 332-4 representing that the image of the “contents D” is a duplex image are displayed. Furthermore, a purchase instruction GUI button to be pressed when a user purchases the “contents D” is displayed thereunder.

In this manner, as introduction information of each contents, an icon representing the type of the image of the contents is displayed. Therefore, a user can readily recognize what the type of the image corresponds to each contents and whether or not the contents can be reproduced using a device owned by a user. As a result, it is possible to suppress a user from erroneously purchasing irreproducible contents.

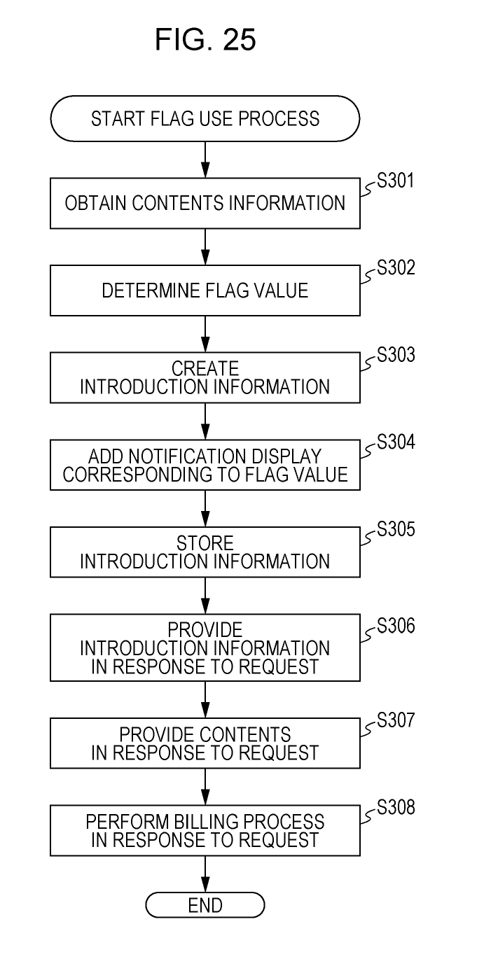

An exemplary flow of the flag use process using such a contents supply server 301 will be described with reference to the flowchart of FIG. 25.

When the flag use process is initiated, the contents information acquisition unit 312 obtains contents information from the contents server 302 in step S301.

In step S302, the flag determination unit 313 determines the flag value included in the obtained contents information.

In step S303, the introduction information creating unit 314 creates the introduction information of the contents based on the contents information. In step S304, the introduction information creating unit 314 adds the notification display (e.g., icon) corresponding to the determined flag value to the introduction information.

In step S305, the supply processing unit 315 stores the created introduction information. In step S306, the supply processing unit 315 supplies the introduction information to the terminal device 303 of the request source in response to the request from the terminal device 303. In step S307, the supply processing unit 315 supplies the contents of the contents server 302 to the terminal device 303 of the request source in response to the request from the terminal device 303.

In step S308, the billing processing unit 316 performs a billing process, as necessary, for the contents supply.

When the process of step S308 is terminated, the flag use process is terminated.

In this manner, the contents supply server 301 can supply the terminal device 303 with information representing the duplex image as well as the in formation representing 2D image or the 3D image using the flag of each contents. That is, the contents supply server 301 can perform a process suitable to the characteristics of the image.

In addition, the configuration of the network system 300 is arbitrarily set. For example, a plurality of contents servers 302 or a plurality of terminal devices 303 may be provided.

### 4. Fourth Embodiment

Configuration of Image Processing Apparatus

While the flag representing the type of the image, that can be used to identify the duplex image as well as the 2D image or the 3D image, is added to the image data (encoded data) in the aforementioned descriptions, a flag representing whether or not the image is a 2D image and disparity information representing the disparity magnitude may be added instead of the aforementioned flag.

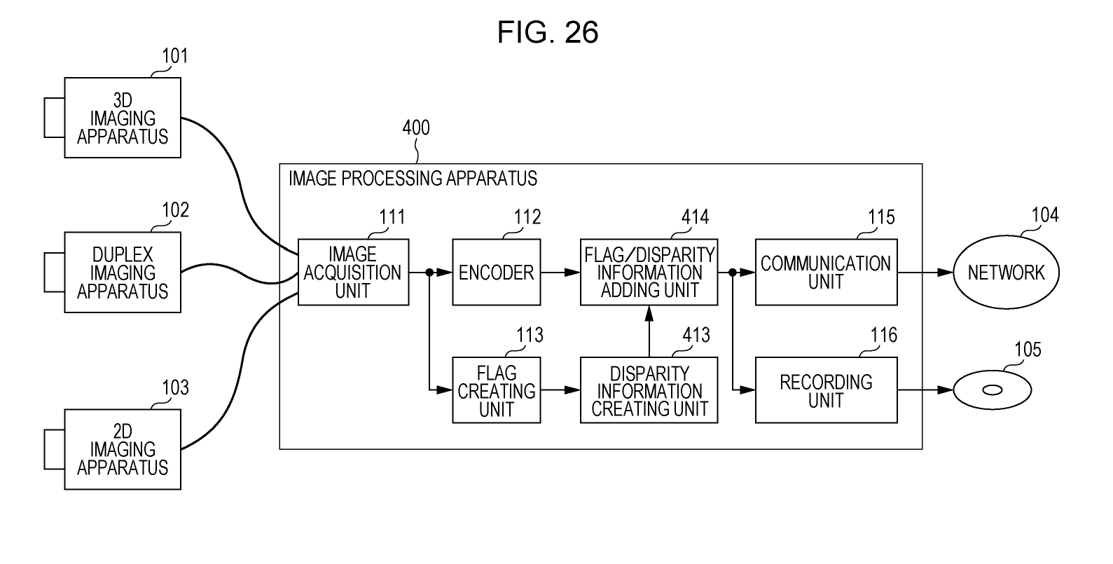

FIG. 26 is a block diagram illustrating another example of the image processing apparatus according to an embodiment of the invention. The image processing apparatus 400 of FIG. 26 basically performs the same process as that of the image processing apparatus 100 of FIG. 1. However, the image processing apparatus 400 adds the flag representing whether or not the image is a 2D image and the disparity information representing the disparity magnitude to the encoded data instead of the flag representing the type of the image.

Therefore, while the image processing apparatus 400 basically has the same configuration as that of the image processing apparatus 100 of FIG. 1, the image processing apparatus 400 further includes the disparity information creating unit 413 in addition to the configuration of the image processing apparatus 100 and includes the flag disparity information adding unit 414 instead of the flag adding unit 114.

The flag creating unit 113 determines the type of the image of the image data, creates the flag representing whether or not the image is a 2D image, and supplies the flag to the disparity information creating unit 413 along with the image data.

When the flag creating unit 113 determines that the image of the image data is a 3D image or a duplex image, and the flag representing that fact is supplied, the disparity information creating unit 413 creates disparity information representing the magnitude of disparity (disparity amount) of the left and right images with reference to the image data. The disparity information creating unit 413 supplies the flag disparity information adding unit 414 with the flag (also including the disparity information when the disparity information is created).

The flag disparity information adding unit 414 adds the flag (and disparity information) supplied from the disparity information creating unit 413 to a predetermined position in the encoded data supplied from the encoder 112. The flag disparity information adding unit 414 supplies the communication unit 115 and the recording unit 116 with the encoded data including the added flag (and the disparity information)

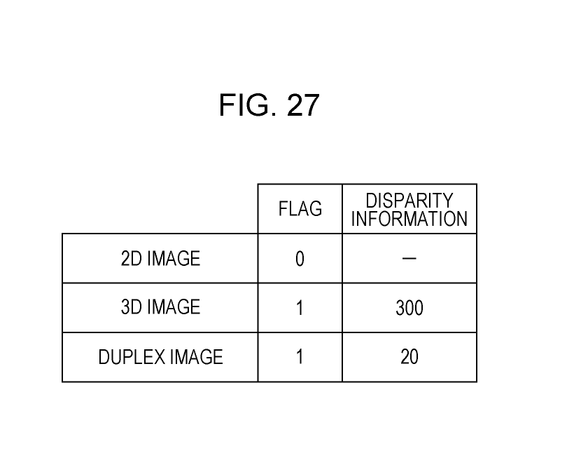

FIG. 27 is a diagram illustrating examples of the flag and the disparity information.

As shown in FIG. 27, the flag creating unit 113 creates a flag value of “0” in the case where the image of the image data is a 2D image. Otherwise, in the case where the image of the image data is a 3D image or a duplex image, i.e., in the case where the image data includes two kinds of (left and right) images, the flag creating unit 113 creates a flag value of “1.”

When the flag creating unit 113 creates the flag value of “1,” i.e., when the image of the image data is a 3D image or a duplex image, the disparity information creating unit 413 obtains the disparity amount between the left and right images, and creates disparity information representing the disparity amount.

Therefore, as shown in FIG. 27, when the image of the image data is the 2D image, a flag having a value of “0” is added to the encoded data. In addition, when the image of the image data is the 3D image, a flag having a value of “1” and disparity information (in the case of the example of FIG. 27, a value “300”) are added to the encoded data. Furthermore, when the image of the image data is the duplex image, a flag having a value of “1” and disparity information (in the case of the example of FIG. 27, a value “20”) are added to the encoded data.

That is, in this case, the image processing apparatus using the flag can identify the type of the image based on the flag and the disparity information.

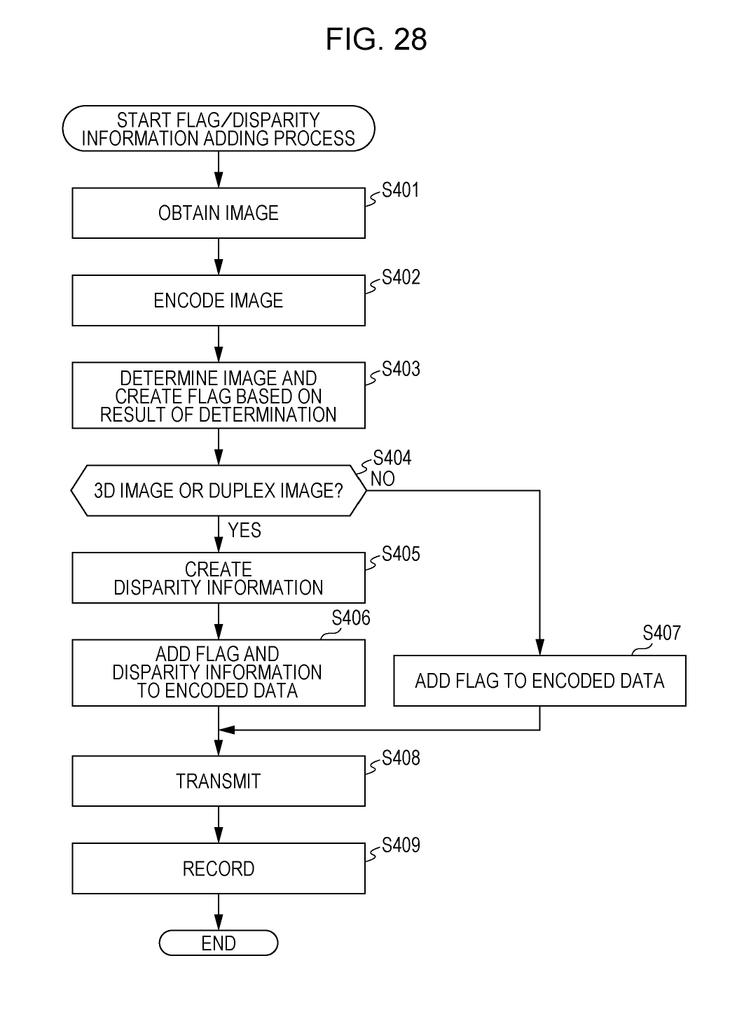

An exemplary flow of the flag/disparity information adding process executed by the image processing apparatus 400 will be described with reference to the flowchart of FIG. 28.

When the flag/disparity information adding process is initiated, in step S401, the image acquisition unit 111 obtains the image data. In step S402, the encoder 112 encodes the image data.

In step S403, the flag creating unit 113 determines the type of the image of the image data and creates a flag having a value corresponding to the determination result.

In step S404, the disparity information creating unit 413 determines whether the image of the image data is a 3D image or a duplex image based on the value of the value of the flag. If it is determined that the image is a 3D image or a duplex image, the process advances to step S405.

In step S405, the disparity information creating unit 413 creates disparity information. In step S406, the flag/disparity information adding unit 414 adds the flag and the disparity information to the encoded data. After the addition, the process advances to step S408.

In step S404, if it is determined that the image is a 2D image, the process advances to step S407.

In step S407, the flag/disparity information adding unit 414 adds the flag to the encoded data. After the addition, the process advances to step S408.

In step S408, the communication unit 115 transmits the encoded data with only the flag being added or with the flag and the disparity information being added.

In step S409, the recording unit 116 records encoded data with only the flag being added or with the flag and the disparity information being added in the removable medium 105.

When the process of step S409 is terminated, the flag/disparity information adding process is terminated.

As described above, the image processing apparatus 400 can add the flag and the disparity information to the encoded data depending on the type of the image. That is, the image processing apparatus 400 can perform a process suitable to the characteristic of the image.

### 5. Fifth Embodiment

Configuration of Image Processing Apparatus

Next, an image processing apparatus for processing the encoded data output from the aforementioned image processing apparatus 400 will be described.

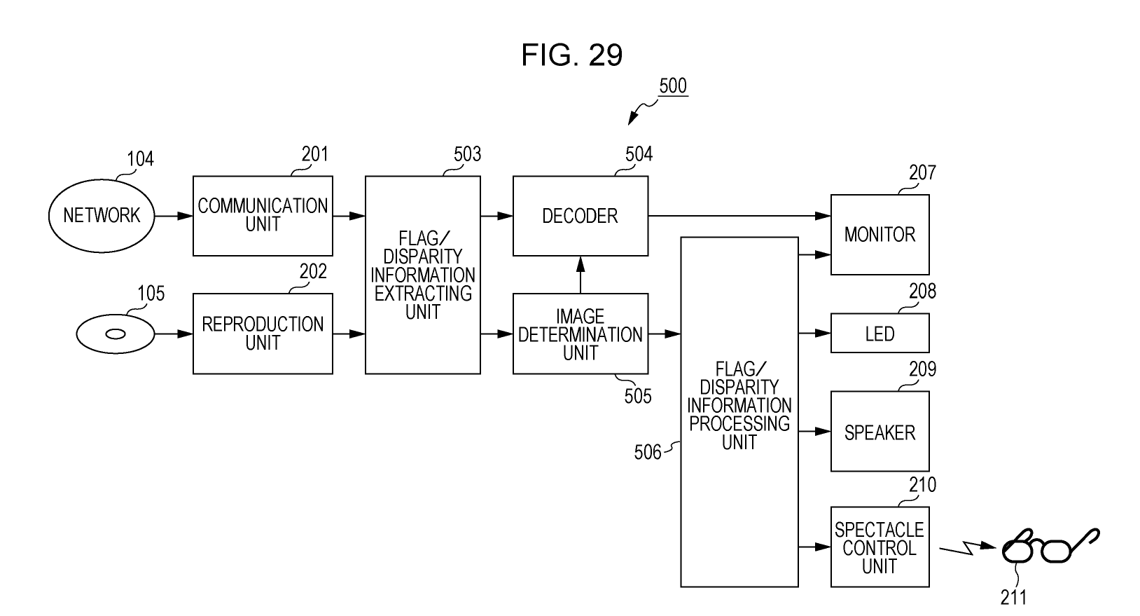

FIG. 29 is a diagram illustrating another configuration example of the image processing apparatus according to an embodiment of the invention. Similar to the image processing apparatus 200, the image processing apparatus 500 decodes the encoded data and performs a process corresponding to the value of the flag added to the encoded data. However, the image processing apparatus 500 also performs a process based on the disparity information added to the encoded data.

Therefore, while the image processing apparatus 500 has basically the same configuration as that of the image processing apparatus 200, it has the flag/disparity information extracting unit 503 in place of the flag extraction unit 203, the decoder 504 in place of the decoder 204, the image determination unit 505 in place of the flag determination unit 205, and the flag/disparity information processing unit 506 in place of the flag processing unit 206.

The flag/disparity information extracting unit 503 extracts the flag added to the encoded data obtained by the communication unit 201 or the reproduction unit 202. In addition, in the case where the disparity information is also added to the encoded data, the flag/disparity information extracting unit 503 also extracts the disparity information.

The flag/disparity information extracting unit 503 supplies the encoded data to the decoder 504 and also supplies the extracted flag (and disparity information) to the image determination unit 505.

The image determination unit 505 determines the type of the image of the encoded data based on the supplied flag or disparity information and supplies the determination result to the flag/disparity information processing unit 506. In addition, the image determination unit 505 also supplies the determination result regarding the type of the image to the decoder 504.

Similar to the decoder 204, the decoder 504 decodes the encoded data. The decoder 504 performs decoding based on the determination result of the image determination unit 505 as necessary. The decoder 504 supplies the decoded image data obtained by decoding the encoded data to the monitor 207.

Similar to the flag processing unit 206, the flag/disparity information processing unit 506 performs notification of the image type or a control process based on the flag or the flag and disparity information.

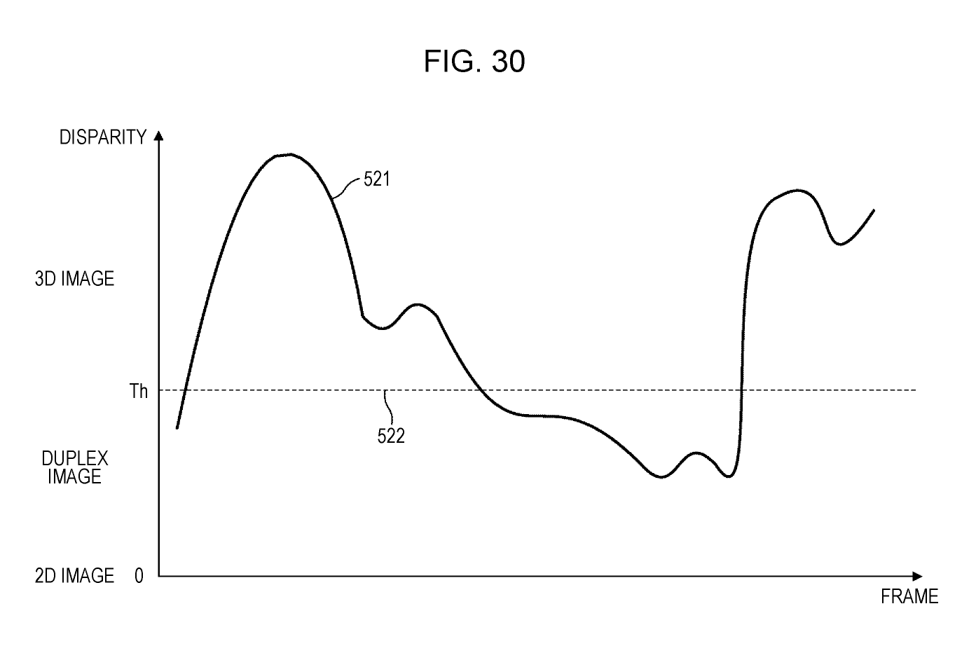

FIG. 30 is a graph illustrating an example of the disparity amount.

Referring to the curve 521 shown in FIG. 30, the disparity information changes in every clip. The image determination unit 505 previously sets the threshold value (Th) for distinguishing between the duplex image and the 3D image to 522, and whether the image is the 3D image or the duplex image is identified based on whether or not the value of the disparity information exceeds the threshold value.

For example, similar to image processing apparatus 200, the flag/disparity information processing unit 506 performs a process corresponding to such a determination result.

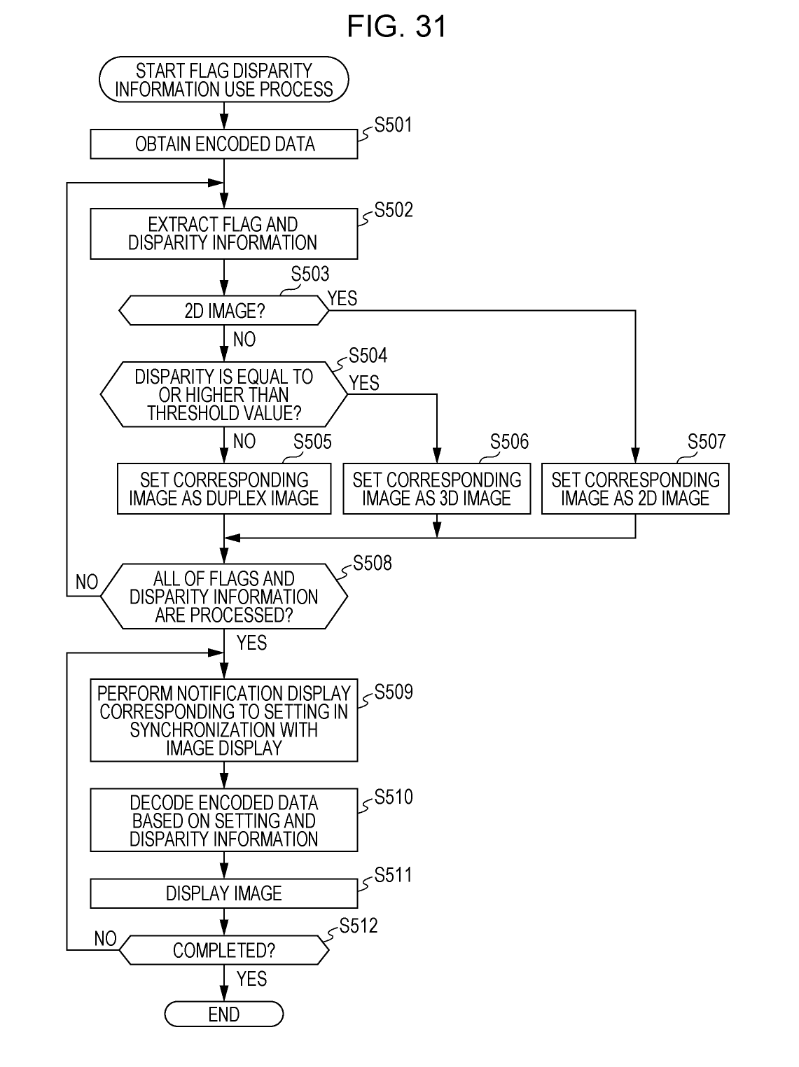

An exemplary flow of the flag/disparity information use process performed by the image processing apparatus 500 will be described with reference to the flowchart of FIG. 31.

When the flag/disparity information use process is initiated, the communication unit 201 or the reproduction unit 202 obtains the encoded data in step S501. In step S502, the flag/disparity information extracting unit 503 extracts the flag and the disparity information from the encoded data.

In step S503, the image determination unit 505 determines the value of the extracted flag and determines whether the image is a 2D image. If it is determined that the image is a 3D image or a duplex image, the process advances to step S504.

In step S504, the image determination unit 505 determines whether or not the disparity level is equal to or higher than the threshold value based on the extracted disparity information. If it is determined that the disparity value is lower than the threshold value, the process advances to step S505.

In step S505, the image determination unit 505 sets the image corresponding to the flag or the disparity information as the duplex image. When the process of step S505 is terminated, the process advances to step S508.

If it is determined that the disparity is equal to or higher than the threshold value in step S504, the process advances to step S506. In step S506, the image determination unit 505 sets the image corresponding to the flag or the disparity information as the 3D image. When the process of step S506 is terminated, the process advances to step S508.

If it is determined that the image is a 2D image based on the flag value in step S503, the process advances to step S507. In step S507, the image determination unit 505 sets the image corresponding to the flag as a 2D image. When the process of step S507 is terminated, the process advances to step S508.

In step S508, the image determination unit 505 determines whether or not all of the flags and disparity information in the clip have been processed. If it is determined that any unprocessed flag or disparity information exists, the process advances to step S502, and the subsequent process is repeated.

In step S508, if it is determined that all of the flags and disparity information are processed, the process advances to step S509.

In step S509, the flag/disparity information processing unit 506 controls the monitor 207 and performs notification display corresponding to the setting in synchronization with the image display.

In step S510, the decoder 504 decodes the encoded data based on the setting and the disparity information.

In step S511, the monitor 507 displays the image.

In step S512, the flag/disparity information processing unit 506 determines whether or not the flag/disparity information use process is terminated. If the entire clip is not yet displayed to the end thereof, and any termination instruction is not received from a user or the like, the process returns to step S509, and the subsequent process is repeated.

If it is determined that the entire clip is displayed to the end or a termination instruction is received from a user or the like in step S512, the flag/disparity information use process is terminated.

In this manner, the image processing apparatus 500 can control the image display based on the flag and the disparity information and process the duplex image distinguished from the 2D image or the 3D image. That is, the image processing apparatus 500 can perform a process suitable to the characteristics of the image.

### 6. Sixth Embodiment

Personal Computer

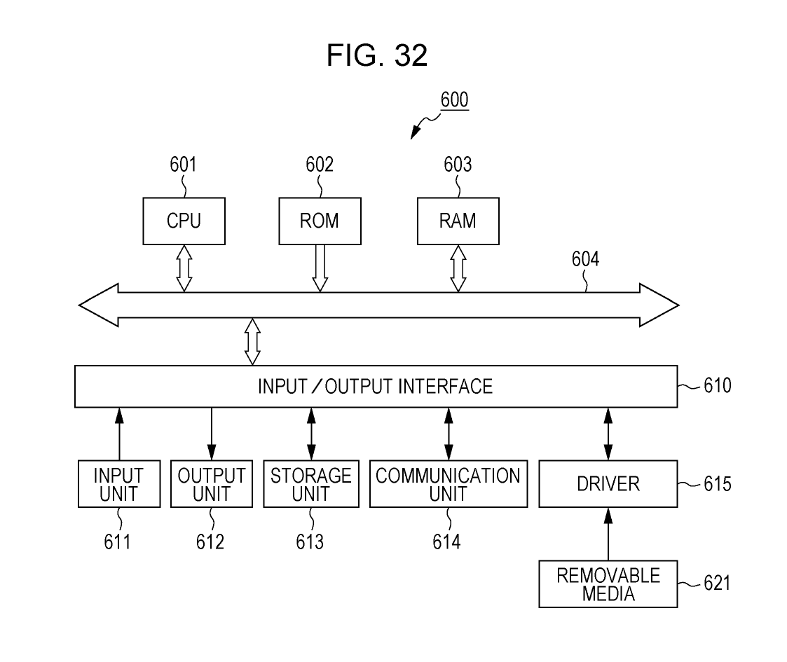

A series of the aforementioned processes may be executed by hardware or software. In this case, for example, the personal computer may be used as shown in FIG. 32.

Referring to FIG. 32, a central processing unit (CPU) 601 of the personal computer 600 executes various processes according to a program stored in a read only memory (ROM) 602 or a program loaded from the storage unit 613 to the random access memory (RAM) 603. The RAM 603 also appropriately stores data necessary for the CPU 601 to execute various processes.

The CPU 601, the ROM 602, and the RAM 603 are connected to one another through the bus 604. In addition, the input/output interface 610 is also connected to the bus 604.

The input/output interface 610 is also connected to an input unit 611 such as a keyboard or a mouse, a display such as a cathode ray tube (CRT) or a liquid crystal display (LCD), an output unit 612 such as a speaker, a storage unit 613 such as a hard disc, and a communication unit 614 such as a modem. The communication unit 614 performs a communication process through a network including the Internet.

The input/output interface 610 is also connected to a drive 615, as necessary, where a removable medium 621 such as a magnetic disc, an optical disc, an optical-magnetic disc, or a semiconductor memory is appropriately installed, and a computer program read therefrom is installed in the storage unit 613 as necessary.

In the case where a series of the aforementioned processes are executed by software, a program included in the software is installed from a network or a recording medium.

Such a recording medium includes, for example, a magnetic disc (including a flexible disc), an optical disc (including a compact disc read only memory (CD-ROM) and a digital versatile disc (DVD)), an optical-magnetic disc (including a mini disc (MD)), or a removable medium 621 including a semiconductor memory, where a program distributed to deliver a program to a user is recorded, in addition to the device mainframe as shown in FIG. 32. In addition, the recording medium includes a ROM 602 previously embedded in the device mainframe and delivered to a user by recording a program thereon, a hard disc included in the storage unit 613, or the like.

Furthermore, the program executed by the computer may be a program processed in a time sequential manner in the order discussed herein. Alternatively, the program may be processed in parallel or at any necessary timing when it is called.

In the present specification, the steps describing the program stored in a recording medium are not necessarily processed in a time sequential manner in the order described herein but also may be processed in parallel or individually.

In the present specification, a system means the entire apparatus including a plurality of devices (or apparatuses).

The element described herein as a single apparatus (or a processing unit) may be divided into a plurality of apparatuses (or processing units). Conversely, the elements described herein as a plurality of apparatuses (or processing units) may be integrated into a single apparatus (or a processing unit). Further, any element other than those described herein may be added to the configuration of each apparatus (or a processing unit). A part of the elements in any apparatus (or a processing unit) may be also included in other apparatuses (or other processing units) if the configuration or operation thereof in a system as a whole is substantially the same. It should be understood by those skilled in the art that the embodiments of the present invention are not intended to limit the scope of the invention, but may be variously changed or modified without departing from the spirit of the present invention.

The present application contains subject matter related to that disclosed in Japanese Priority Patent Application JP 2009-296950 filed in the Japan Patent Office on Dec. 28, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a creating means that creates identification information identifying a type of an image of image data among a 2D image for planar viewing, a 3D image for stereoscopic viewing including left and right images, and a duplex image which is capable of both stereoscopic viewing including the left and right images and planar viewing with disparity lower than that of the 3D image; and
a transmitting means that transmits the identification information created by the creating means and the image data.

2. The image processing apparatus according to claim 1, further comprising an encoding means that encodes the image data to create encoded data, wherein the transmitting means transmits the identification information created by the creating means and the encoded data created by the encoding means.

3. The image processing apparatus according to claim 1, wherein the creating means creates, as identification information, a flag having a value of “00” when the image of the image data corresponds to the 2D image, creates a flag having a value of “10” when the image of the image data corresponds to the 3D image, and creates a flag having a value of “01” or “11” when the image of the image data corresponds to the duplex image.

4. The image processing apparatus according to claim 1, wherein the creating means creates, as identification information, a flag having a value of “10” when the image of the image data corresponds to the 2D image, creates a flag having a value of “01” when the image of the image data corresponds to the 3D image, and creates a flag having a value of “11” when the image of the image data corresponds to the duplex image.

5. An image processing method of an image processing apparatus, the method comprising:
creating, as identification information, a flag identifying an image of image data corresponds to which one of a 2D image for planar viewing, a 3D image for stereoscopic viewing including left and right images, and a duplex image which is capable of both stereoscopic viewing including the left and right images and planar viewing with disparity lower than that of the 3D image; and
transmitting the created flag and the image data.

6. An image processing apparatus comprising:
a receiving means that receives image data and identification information identifying a type of an image of image data among a 2D image for planar viewing, a 3D image for stereoscopic viewing including left and right images, and a duplex image which is capable of both stereoscopic viewing including the left and right images and planar viewing with disparity lower than that of the 3D image;
a determination means that determines a value of the identification information received by the receiving means; and
a processing means that performs a process corresponding to the value determined by the determination means.

7. The image processing apparatus according to claim 6, wherein the processing means displays an icon corresponding to the type of the image of the image data indicated by the value determined by the determination means.

8. The image processing apparatus according to claim 6, wherein the processing means turns a light emitting diode (LED) on or off depending on the type of the image of the image data indicated by the value determined by the determination means.

9. The image processing apparatus according to claim 6, wherein the processing means sets and displays a display size of the image of the image data based on the type of the image of the image data indicated by the value determined by the determination means.

10. The image processing apparatus according to claim 6, wherein the processing means sets and displays an aspect ratio of the image of the image data based on the type of the image of the image data indicated by the value determined by the determination means.

11. The image processing apparatus according to claim 6, wherein the processing means sets and displays a thickness of an image frame of the image of the image data based on the type of the image of the image data indicated by the value determined by the determination means.

12. The image processing apparatus according to claim 6, wherein the processing means outputs a voice as notification of the type of the image of the image data indicated by the value determined by the determination means.

13. The image processing apparatus according to claim 6, wherein the processing means controls 3D spectacles used by a user when the image of the image data is seen stereoscopically to notify a user of the type of the image of the image data indicated by the value determined by the determination means.

14. The image processing apparatus according to claim 6, wherein the processing means displays a notification image as notification of the type of the image of the image data indicated by the value determined by the determination means before displaying the image of the image data.

15. An image processing method of an image processing apparatus, the method comprising:
receiving image data and identification information identifying a type of an image of image data among a 2D image for planar viewing, a 3D image for stereoscopic viewing including left and right images, and a duplex image which is capable of both stereoscopic viewing including the left and right images and planar viewing with disparity lower than that of the 3D image;
determining a value of the received identification information; and
performing a process corresponding to the determined value.

16. An image processing apparatus comprising:
a creating unit that creates, as identification information, a flag identifying a type of an image of image data among a 2D image for planar viewing, a 3D image for stereoscopic viewing including left and right images, and a duplex image which is capable of both stereoscopic viewing including the left and right images and planar viewing with disparity lower than that of the 3D image; and
a transmitting unit that transmits the flag created by the creating unit and the image data.

17. An image processing apparatus comprising:
a receiving unit that receives image data and identification information identifying a type of an image of image data among a 2D image for planar viewing, a 3D image for stereoscopic viewing including left and right images, and a duplex image which is capable of both stereoscopic viewing including the left and right images and planar viewing with disparity lower than that of the 3D image;
a determination unit that determines a value of the identification information received by the receiving unit; and
a processing unit that performs a process corresponding to the value determined by the determination unit.
